(19) United States
(12) Patent Application Publication
(10) Pub. No.: US 2017/0238547 A1
(43) Pub. Date: Aug. 24, 2017

(54) ANTIBACTERIAL AND/OR ANTIFOULING POLYMERS

(71) Applicant: AGENCY FOR SCIENCE, TECHNOLOGY AND RESEARCH, Singapore (SG)

(72) Inventors: Yi Yan YANG, Singapore (SG); Zhi Xiang VOO, Singapore (SG)

(21) Appl. No.: 15/519,534

(22) PCT Filed: Oct. 14, 2015
(86) PCT No.: PCT/SG2015/050388

§ 371 Date: Apr. 14, 2017

(30) Foreign Application Priority Data
Oct. 14, 2014 (SG) 10201406601U

(51) Int. Cl. A01N 47/06; C09D 169/00; C08G 64/18; C08G 64/40; C09D 5/14; A01N 25/08

(52) U.S. Cl. CPC A01N 47/06; C09D 5/14; A01N 25/08; C08G 64/183; C08G 64/40; C09D 169/00

(57) ABSTRACT

The present disclosure provides a copolymer comprising monomer units represented by formulas (I) and/or (II) as disclosed and defined herein which are useful in antibacterial and/or antifouling coatings. The present disclosure further provides methods of synthesizing said copolymers.

### CROSS-REFERENCE TO RELATED APPLICATIONS

This application claims the benefit of priority of Singapore application No. SG 10201406601U, filed 14 Oct. 2014, the contents of it being hereby incorporated by reference in its entirety for all purposes.

### TECHNICAL FIELD

The present invention generally relates to polymers useful as antibacterial and antifouling coatings. The present invention also relates to methods of synthesizing said polymers.

### BACKGROUND ART

Silicone is a ubiquitous material for many different devices, such as stents, catheters, prostheses, contact lenses and microfluidics. It has low transition temperature and is hydrophobic, allowing the material to be inert to intravenous and body fluids. Silicone is also nontoxic, and possesses both thermal and chemical stability; hence it is an attractive material for biomedical applications. However, it is prone to protein adsorption due to its hydrophobic nature, and protein fouling can occur in a matter of seconds after implantation and exposure to body fluids, resulting in blood clots and subsequent thrombosis. Once proteins form the topmost layer on the silicone surface, microbes such as bacteria and fungi can easily anchor onto the surface. As such, catheter-associated nosocomial infections account for most hospital-related infections that lead to exorbitant costs, and amount to more than 3 billion dollars annually in the United States of America alone.

Among various types of bacteria, Staphylococcus aureus and Escherichia coli are common bacteria found to foul the silicone surface via non-specific and specific adhesion. Eventually, bacterial cell proliferation and adhesion results in the formation of biofilm on the surface. The biofilm increases bacteria survivability and tolerance to antibiotics by many folds. Moreover, removing the biofilm-infected devices may not solve the problem completely due to residual microbes, which causes recurring infections. Several strategies have been devised to prevent biofilm formation. Some of these strategies employ antibiotics, silver ions or quaternized ammonium ions in a medical device. But these strategies also suffer from burst release, drug resistance and increase in biofilm formation. Another technique utilizes antifouling agents, such as zwitterions or hydrophilic poly(ethylene glycol). These methods may prevent the microbes from attaching to the surface for a certain period of time without killing the microbes, eventually leading to fouling. Therefore, there is an urgent need to develop novel methods and materials that possess robust antibacterial and antifouling properties in a sustained manner.

### SUMMARY

In a first aspect of the present disclosure, there is provided a copolymer comprising monomer units represented by formulas (I) and/or (II):

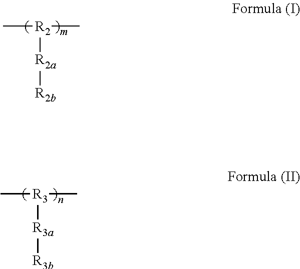

wherein the copolymer is terminated on one end by R₁ and on the other end by R₄;
   R₁ comprises an antifouling moiety;
   R₄ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
   R₂ and R₃ are independently optionally substituted hetero-C₁₋₁₀-alkyl, wherein one or more chain carbon atoms is optionally replaced by a heteroatom;
   R₂ₐ and R₃ₐ are independently optionally substituted hetero-C₁₋₁₀-alkyl, wherein one or more chain carbon atoms is optionally replaced by a heteroatom;
   R_{2b} comprises an anchoring moiety;
   R_{3b} comprises an antibacterial moiety;
   m is an integer in the range of 1 to 20; and
   n is an integer in the range of 0 to 100.

In a second aspect of the present disclosure, there is provided a method of synthesizing a copolymer comprising monomer units represented by formulas (IIIA) and/or (IIIB):

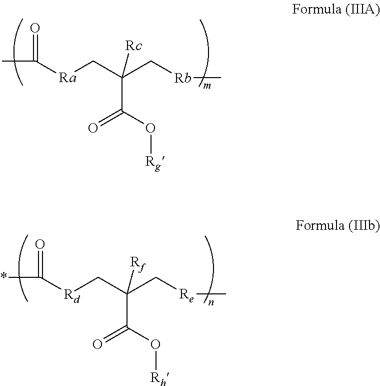

wherein the copolymer is terminated on one end by R₁ and on the other end by R₄;
   R₁ is a polymer residue comprising an antifouling moiety;
   R₄ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
   Rₐ, R_{b}, R_{c}, R_{d}, Rₑ and R_{f} are independently C(R₅)₂, O or N(R₅);
      R₅ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
   R_{g}′ represents protected R_{g}, and Rₕ′ represents aryl or heteroaryl substituted with at least one substituent capable of being quaternized,
      wherein R_{g} comprises an anchoring moiety;
   m is an integer in the range of 1 to 20; and
   n is an integer in the range of 0 to 100,
the method comprising the step of:
(i) performing a ring-opening polymerization reaction in a reaction mixture comprising compounds of Formula (IC), H—R₁, and compounds of Formula (IIC):

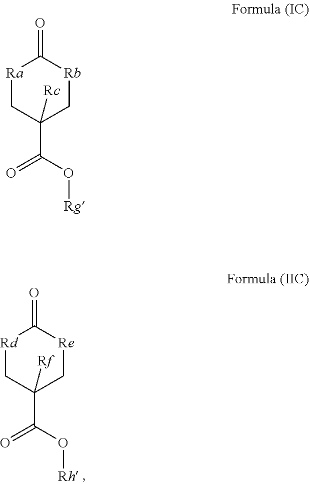

with the proviso that compounds of Formula (IIC) are present only when n≠0,
thereby forming a copolymer comprising monomer units of Formula (IIIA) and/or (IIIB).

In a third aspect of the present disclosure, there is provided a method of attaching a copolymer according to the first aspect to a substrate, comprising attaching the anchoring moiety of said copolymer to an anchoring segment on said substrate.

In a fourth aspect of the present disclosure, there is provided an article comprising a substrate and a coating comprising the copolymer according to the first aspect.

In a fifth aspect of the present disclosure, there is provided a use of a copolymer according to the first aspect for imparting an antibacterial and/or antifouling surface to an article.

### Definitions

The following words and terms used herein shall have the meaning indicated:

As used herein, the term “alkyl” includes within its meaning monovalent (“alkyl”) and divalent (“alkylene”) straight chain or branched chain saturated aliphatic groups having from 1 to 12 carbon atoms, eg, 1, 2, 3, 4, 5, 6, 7, 8, 9, 10, 11 or 12 carbon atoms. For example, the term alkyl includes, but is not limited to, methyl, ethyl, I-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, I-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, undecyl, dodecyl and the like. Alkyl groups may be optionally substituted.

As used herein, the term “alkenyl” refers to divalent straight chain or branched chain unsaturated aliphatic groups containing at least one carbon-carbon double bond and having from 2 to 12 carbon atoms, eg, 2, 3, 4, 5, 6, 7, 8, 9, 10, 11 or 12 carbon atoms. For example, the term alkenyl includes, but is not limited to, ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, 1,5-hexadienyl and the like. Alkenyl groups may be optionally substituted.

As used herein, the term “alkynyl” refers to trivalent straight chain or branched chain unsaturated aliphatic groups containing at least one carbon-carbon triple bond and having from 2 to 12 carbon atoms, eg, 2, 3, 4, 5, 6, 7, 8, 9, 10, 11 or 12 carbon atoms. For example, the term alkynyl includes, but is not limited to, ethynyl, propynyl, 1-butynyl, 2-butynyl, 1-pentynyl, 2-pentynyl, 1-hexynyl, 2-hexynyl, 3-hexynyl, 3-methyl-1-pentynyl, and the like. Alkynyl groups may be optionally substituted.

The term “aryl”, or variants such as “aromatic group” or “arylene” as used herein refers to monovalent (“aryl”) and divalent (“arylene”) single, polynuclear, conjugated or fused residues of aromatic hydrocarbons having from 6 to 10 carbon atoms. Such groups include, for example, phenyl, biphenyl, naphthyl, phenanthrenyl, and the like. Aryl groups may be optionally substituted.

The term “carbocycle”, or variants such as “carbocyclic ring” as used herein, includes within its meaning any stable 3, 4, 5, 6, or 7-membered monocyclic or bicyclic or 7, 8, 9, 10, 11, 12, or 13-membered bicyclic or tricyclic, any of which may be saturated, partially unsaturated, or aromatic. Examples of such carbocycles include, but are not limited to, cyclopropyl, cyclobutyl, cyclopentyl, cyclohexyl, cycloheptyl, adamantyl, cyclooctyl, [3.3.0]bicyclooctane, [4.3.0]bicyclononane, [4.4.0]bicyclodecane (decalin), [2.2.2]bicyclooctane, fluorenyl, phenyl, naphthyl, indanyl, adamantyl, or tetrahydronaphthyl (tetralin). Preferred carbocycles, unless otherwise specified, are cyclopropyl, cyclobutyl, cyclopentyl, cyclohexyl, phenyl, naphthyl, and indanyl. When the term “carbocycle” is used, it is intended to include “aryl”. Carbocycles may be optionally substituted.

The term “heteroalkyl” as used herein refers to an alkyl moiety as defined above, having one or more carbon atoms, for example 1, 2, 3, 4, 5, 6, 7, 8, 9, 10 carbon atoms, replaced with one or more heteroatoms, which may be the same or different, where the point of attachment to the remainder of the molecule is through a carbon atom of the heteroalkyl radical, or the heteroatom. Suitable heteroatoms include O, S, and N. Non-limiting examples include ethers, thioethers, amines, hydroxymethyl, 3-hydroxypropyl, 1,2-dihydroxyethyl, 2-methoxyethyl, 2-aminoethyl, 2-dimethylaminoethyl, and the like. Heteroalkyl groups may be optionally substituted.

The term “heteroaryl” as used herein refers to an aromatic monocyclic or multicyclic ring system comprising about 5 to about 14 ring atoms, preferably about 5 to about 10 ring atoms, preferably about 5, 6, 7, 8, 9, 10, 11, 12, 13 or 14 ring atoms, in which one or more of the ring atoms is an element other than carbon, for example nitrogen, oxygen or sulfur, alone or in combination. “Heteroaryl” may also include a heteroaryl as defined above fused to an aryl as defined above. Non-limiting examples of suitable heteroaryls include pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl and the like. The term “heteroaryl” also refers to partially saturated heteroaryl moieties such as, for example, tetrahydroisoquinolyl, tetrahydroquinolyl and the like. Heteroaryl groups may be optionally substituted.

The term “heterocycle” or “heterocarbocyclyl” as used herein refers to a group comprising a covalently closed ring herein at least one atom forming the ring is a carbon atom and at least one atom forming the ring is a heteroatom. Heterocyclic rings may be formed by three, four, five, six, seven, eight, nine, or more than nine atoms, any of which may be saturated, partially unsaturated, or aromatic. Any number of those atoms may be heteroatoms (i.e., a heterocyclic ring may comprise one, two, three, four, five, six, seven, eight, nine, or more than nine heteroatoms). Herein, whenever the number of carbon atoms in a heterocycle is indicated (e.g., C1-C6 heterocycle), at least one other atom (the heteroatom) must be present in the ring. Designations such as “C1-C6 heterocycle” refer only to the number of carbon atoms in the ring and do not refer to the total number of atoms in the ring. It is understood that the heterocylic ring will have additional heteroatoms in the ring. In heterocycles comprising two or more heteroatoms, those two or more heteroatoms may be the same or different from one another. Heterocycles may be optionally substituted. Binding to a heterocycle can be at a heteroatom or via a carbon atom. Examples of heterocycles include heterocycloalkyls (where the ring contains fully saturated bonds) and heterocycloalkenyls (where the ring contains one or more unsaturated bonds) such as, but are not limited to the following:

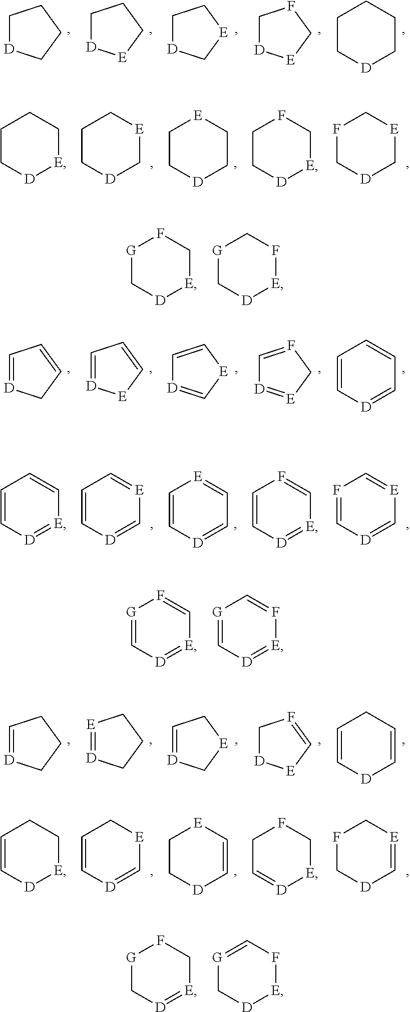

wherein D, E, F, and G independently represent a heteroatom. Each of D, E, F, and G may be the same or different from one another.

When compounded chemical names, e.g. “arylalkyl” and “arylimine” are used herein, they are understood to have a specific connectivity to the core of the chemical structure. The group listed farthest to the right (e.g. alkyl in “arylalkyl”), is the group that is directly connected to the core. Thus, an “arylalkyl” group, for example, is an alkyl group substituted with an aryl group (e.g. phenylmethyl (i.e., benzyl)) and the alkyl group is attached to the core. An “alkylaryl” group is an aryl group substituted with an alkyl group (e.g., p-methylphenyl (i.e., p-tolyl)) and the aryl group is attached to the core

The term “anchoring moiety” as used herein refers to an atomic or molecular group that is capable of forming covalent bonds between the disclosed copolymer and a chosen substrate. Numerous methods and reagents which can be used to anchor organic molecules to substrates are known to those skilled in the art; any such method can be used, provided that it does not destroy the copolymer. For example, if the substrate comprises acrylamide, the anchoring groups can contain unsaturated bonds, such as vinyl, allyl, acryl, or methacryl groups. Alternatively, if the substrate comprises primary or secondary amine groups, the anchoring groups can comprise lactones, aldehydes, or epoxides. If the substrate comprises hydroxyl groups, then the hydroxyl groups of the reagent can be protected before the anchoring reaction, and the anchoring groups can comprise epoxides, lactones, halogen anhydrides, or alkyl halogens. If the substrate comprises thiol groups, the anchoring groups can comprise a α-β-unsaturated carbonyl group such as maleic acid, maleamic acid and maleimide groups. The anchoring group may be protected before the anchoring reaction. The anchoring reaction may comprise a Michael addition reaction.

The term “antifouling moiety” as used herein refers to a molecular group that is capable of inhibiting the attachment and/or growth of a biofouling organism. The antifouling moiety may comprise a methoxyethyl group. The antifouling moiety may be part of a polymer residue. Suitable polymer residues include, but are not limited to, poly(ethylene glycol) (PEG), poly(methoxyethyl acrylate) (PMEA), poly(phosphorylcholine methacrylate), and glycomimetic polymer residues.

The term “antibacterial moiety” as used herein refers to a molecular group that is capable of inhibiting the attachment and/or growth of a bacteria and/or microorganism. The antibacterial moiety may comprise a cation, antibiotics or silver ions. The antibacterial moiety may comprise a quaternary ammonium group.

The term “optionally substituted” as used herein means the group to which this term refers may be unsubstituted, or may be substituted with one or more groups other than hydrogen provided that the indicated atom's normal valency is not exceeded, and that the substitution results in a stable compound. Such groups may be, for example, halogen, hydroxy, oxo, cyano, nitro, alkyl, alkoxy, haloalkyl, haloalkoxy, aryl-4-alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of the presently disclosed copolymers and methods will now be disclosed.

In the present disclosure, MPEG incorporated cationic polycarbonate polymers were tethered to silicone surfaces in a covalent manner at specific anchorage points in order to determine antimicrobial and antifouling properties of the modified surfaces. Known polycarbonate polymers may eradiate multidrug resistant microbes via membrane-lytic mechanism while displaying minimal toxicity. However, these polymers are coated via a reactive thiol end-group deposited onto the surface through non-covalent interactions prior to polymer coating. Advantageously, the present disclosed polymers display enhanced durability through covalent coating onto a surface.

In the present disclosure, monomethylether PEG (MPEG) with 2.4 kDa was used as a macroinitiator to ring-open the cyclic carbonate monomers MTC-Furan protected maleimide (MTC-FPM) and MTC-benzyl chloride (MTC-OCH₂BnCl) in a sequential order, followed by deprotection to expose the maleimide anchoring groups, and subsequent complete quaternization with dimethyl butyl amine to yield triblock copolymers of MPEG, maleimide-functionalized polycarbonate (PMC) and cationic polycarbonate (CPC), i.e. MPEG-PMC-CPC and MPEG-CPC-PMC (Scheme 3, Table 1). Each of the polymers had MPEG of the same molecular weight for providing antifouling function, cationic polycarbonates of comparable length for antibacterial property and maleimide-functionalized polycarbonate for surface attachment via Michael addition reaction. ¹H NMR integration values of monomers against the MPEG initiator were correlated, hence confirming controlled polymerization via initial monomer to initiator feed ratio. In addition, the proton NMR analysis displayed all the peaks associated with both initiator and monomers. Both polymers had narrow molecular weight distribution with polydispersity index (PDI) ranging between 1.20 to 1.28. Subsequently, after precipitating twice in cold diethyl ether, the two polymers were isolated and dried. The polymers were subsequently dissolved in toluene and heated to 110° C. overnight for the deprotection of pendant furan-protected maleimide. The deprotected polymers were reprecipitated in cold diethyl ether twice, and ¹H NMR showed a downfield shift from 6.49 to 6.68 ppm, which was correlated to the deprotected maleimide pendant groups. Excess quantity of N, N-dimethylbutylamine was then added to the polymers dissolved in 20 mL of acetonitrile to achieve complete quaternization. The fully quaternized polymers were purified via dialysis in acetonitrile/isopropanol (1:1 in volume) for 2 days. From 1H NMR analysis, the presence of a new distinct peak at 2.99 ppm confirmed that quaternization of —OCH2BnCl pendant groups took place (Figure S1 in the Supplementary Information—SI).

Besides the triblock copolymers as discussed above, diblock polymers of MPEG with Mn 2.4 kDa/10 kDa and malemide-functionalized polycarbonate for anchoring onto thiol-functionalized catheter surfaces (PEG-PMC) were synthesized by organocatalytic ring-opening polymerization. Similarly, diblock copolymers of PEG with Mn 2.4 kDa/10 kDa and cationic P(C-M), where maleimide groups and cationic groups were randomly distributed, were synthesized as a comparison. The polymers may be coated onto thiol-functionalized catheter surface through Michael addition chemistry. The antibacterial and antifouling activities of these coatings were evaluated using various methods.

In one aspect of the present disclosure, there is provided a copolymer (CP) comprising monomer units represented by formulas (I) and/or (II):

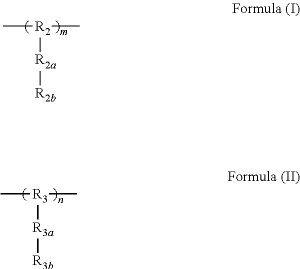

wherein the copolymer is terminated on one end by R₁ and on the other end by R₄;
R₁ comprises an antifouling moiety;
R₄ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
R₂ and R₃ are independently optionally substituted hetero-C₁₋₁₀-alkyl, wherein one or more chain carbon atoms is optionally replaced by a heteroatom;
R₂ₐ and R₃ₐ are independently optionally substituted hetero-C₁₋₁₀-alkyl, wherein one or more chain carbon atoms is optionally replaced by a heteroatom;
R_{2b} comprises an anchoring moiety;
R_{3b} comprises an antibacterial moiety;
m is an integer in the range of 1 to 20; and
n is an integer in the range of 0 to 100.

In Formula (I), m may be an integer in the range of 1 to 20, or 5 to 20, or 10 to 20, or 15 to 20, or 1 to 15, or 1 to 10, or 1 to 5. The integer m may be 1, 2, 3, 4, 5, 6, 7, 8, 9, 10, 11, 12, 13, 14, 15, 16, 17, 18, 19, or 20.

In Formula (II), n may be an integer in the range of 0 to 100, or 10 to 100, or 20 to 100, or 30 to 100, or 40 to 100, or 50 to 100, or 60 to 100, or 70 to 100, or 80 to 100, or 90 to 100. The integer n may be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 85, 86, 87, 88, 89, 90, 91, 92, 93, 94, 95, 96, 97, 98, 99, or 100.

R₁ may be a polymer residue. R₁ may be a polymer residue with a molecular weight in the range of about 2,000 to about 20,000, or about 3,000 to about 20,000, or about 4,000 to about 20,000, or about 5,000 to about 20,000, or about 6,000 to about 20,000, or about 7,000 to about 20,000, or about 8,000 to about 20,000, or about 9,000 to about 20,000, or about 10,000 to about 20,000, or about 11,000 to about 20,000, or about 12,000 to about 20,000, or about 13,000 to about 20,000, or about 14,000 to about 20,000, or about 15,000 to about 20,000, or about 16,000 to about 20,000, or about 17,000 to about 20,000, or about 18,000 to about 20,000, or about 19,000 to about 20,000, or about 2,000 to about 19,000, or about 2,000 to about 18,000, or about 2,000 to about 17,000, or about 2,000 to about 16,000, or about 2,000 to about 15,000, or about 2,000 to about 14,000, or about 2,000 to about 13,000, or about 2,000 to about 12,000, or about 2,000 to about 11,000, or about 2,000 to about 10,000, or about 2,000 to about 9,000, or about 2,000 to about 8,000, or about 2,000 to about 7,000, or about 2,000 to about 6,000, or about 2,000 to about 5,000, or about 2,000 to about 4,000, or about 2,000 to about 3,000.

R₁ may be a polymer residue comprising or consisting of an antifouling moiety. In some embodiments, R₁ may be selected from the group consisting of poly(oxyalkylene), methoxypoly(oxyalkylene), and poly(alkoxy acrylate). R₁ may be selected from the group consisting of poly(ethylene glycol) (PEG), methoxypoly(ethylene glycol) (mPEG), poly(methoxyethyl methacrylate) and poly(ethoxyethyl methacrylate).

R₄ may be H, optionally substituted alkyl, optionally substituted alkenyl, optionally substituted alkynyl, optionally substituted aryl, optionally substituted heteroaryl, optionally substituted carbocycle, or optionally substituted heterocarbocycle.

In some embodiments, R₄ may be optionally substituted C₁ to C₁₀ alkyl. R₄ may be optionally substituted methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, undecyl, or dodecyl.

In some embodiments, R₄ may be optionally substituted C₂ to C₁₂ alkenyl. R₄ may be optionally substituted ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, or 1,5-hexadienyl.

In some embodiments, R₄ may be optionally substituted C₂ to C₁₂ alkynyl. R₄ may be optionally substituted ethynyl, propynyl, 1-butynyl, 2-butynyl, 1-pentynyl, 2-pentynyl, 1-hexynyl, 2-hexynyl, 3-hexynyl, or 3-methyl-1-pentynyl.

In some embodiments, R₄ may be optionally substituted C₆ to C₁₀ aryl. R₄ may be optionally substituted phenyl, biphenyl, naphthyl, or phenanthrenyl.

In some embodiments, R₄ may be optionally substituted C₅ to C₁₄ heteroaryl. R₄ may be an optionally substituted aromatic monocyclic or a multicyclic ring system comprising about 5 to about 14 ring atoms in which one or more of the ring atoms is an element other than carbon, for example nitrogen, oxygen or sulfur, alone or in combination. R₄ may be optionally substituted pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl, tetrahydroisoquinolyl, or tetrahydroquinolyl.

In some embodiments, R₄ may be optionally substituted C₃ to C₁₃ monocyclic, bicyclic or tricyclic ring, any of which may be saturated, partially unsaturated, or aromatic. R₄ may be cyclopropyl, cyclobutyl, cyclopentyl, cyclohexyl, cycloheptyl, adamantyl, cyclooctyl, [3.3.0]bicyclooctane, [4.3.0]bicyclononane, [4.4.0]bicyclodecane (decalin), [2.2.2]bicyclooctane, fluorenyl, phenyl, naphthyl, indanyl, adamantyl, or tetrahydronaphthyl (tetralin).

Each of R₂ or R₃ may be optionally substituted hetero-C₁₋₁₀-alkyl, wherein one or more chain carbon atoms is optionally replaced by a heteroatom. The heteroatom may be 0, S, or N.

R₂ or R₃ may each be an optionally substituted C₄, C₅ or C₆-alkyl.

R₂ or R₃ may each be an optionally substituted C₄-heteroalkyl wherein 1 carbon atom is replaced by an O. R₂ or R₃ may each be an optionally substituted C₄-heteroalkyl wherein 1 carbon atom is replaced by an S. R₂ or R₃ may each be an optionally substituted C₄-heteroalkyl wherein 1 carbon atom is replaced by an N.

R₂ or R₃ may each be an optionally substituted C₄-heteroalkyl wherein 2 carbon atoms are replaced by an O, S or N. R₂ or R₃ may each be an optionally substituted C₄-heteroalkyl wherein 2 carbon atoms are replaced by two O atoms. R₂ or R₃ may each be an optionally C₄-heteroalkyl wherein 2 carbon atoms are replaced by two S atoms. R₂ or R₃ may each be an optionally substituted C₄-heteroalkyl wherein 2 carbon atoms are replaced by two N atoms. R₂ or R₃ may each be an optionally substituted C₄-heteroalkyl wherein 1 carbon atom is replaced by an O, and 1 carbon atom is replaced by an S. R₂ or R₃ may each be an optionally substituted C₄-heteroalkyl wherein 1 carbon atom is replaced by an O, and 1 carbon atom is replaced by an N. R₂ or R₃ may each be an optionally substituted C₄-heteroalkyl wherein 1 carbon atom is replaced by an S, and 1 carbon atom is replaced by an N.

R₂ or R₃ may each be an optionally substituted C₅-heteroalkyl wherein 1 carbon atom is replaced by an O. R₂ or R₃ may each be an optionally substituted C₅-heteroalkyl wherein 1 carbon atom is replaced by an S. R₂ or R₃ may each be an optionally substituted C₅-heteroalkyl wherein 1 carbon atom is replaced by an N.

R₂ or R₃ may each be an optionally substituted C₅-heteroalkyl wherein 2 carbon atoms are replaced by an O, S or N. R₂ or R₃ may each be an optionally substituted C₅-heteroalkyl wherein 2 carbon atoms are replaced by two O atoms. R₂ or R₃ may each be an optionally substituted C₅-heteroalkyl wherein 2 carbon atoms are replaced by two S atoms. R₂ or R₃ may each be an optionally substituted C₅-heteroalkyl wherein 2 carbon atoms are replaced by two N atoms. R₂ or R₃ may each be an optionally substituted C₅-heteroalkyl wherein 1 carbon atom is replaced by an O, and 1 carbon atom is replaced by an S. R₂ or R₃ may each be an optionally substituted C₅-heteroalkyl wherein 1 carbon atom is replaced by an O, and 1 carbon atom is replaced by an N. R₂ or R₃ may each be an optionally substituted C₅-heteroalkyl wherein 1 carbon atom is replaced by an S, and 1 carbon atom is replaced by an N.

R₂ or R₃ may each be an optionally substituted C₆-heteroalkyl wherein 1 carbon atom is replaced by an O. R₂ or R₃ may each be an optionally substituted C₆-heteroalkyl wherein 1 carbon atom is replaced by an S. R₂ or R₃ may each be an optionally substituted C₆-heteroalkyl wherein 1 carbon atom is replaced by an N.

R₂ or R₃ may each be an optionally substituted C₆-heteroalkyl wherein 2 carbon atoms are replaced by an O, S or N. R₂ or R₃ may each be an optionally substituted C₆-heteroalkyl wherein 2 carbon atoms are replaced by two O atoms. R₂ or R₃ may each be an optionally substituted C₆-heteroalkyl wherein 2 carbon atoms are replaced by two S atoms. R₂ or R₃ may each be an optionally substituted C₆-heteroalkyl wherein 2 carbon atoms are replaced by two N atoms. R₂ or R₃ may each be an optionally substituted C₆-heteroalkyl wherein 1 carbon atom is replaced by an O, and 1 carbon atom is replaced by an S. R₂ or R₃ may each be an optionally substituted C₆-heteroalkyl wherein 1 carbon atom is replaced by an O, and 1 carbon atom is replaced by an N. R₂ or R₃ may each be an optionally substituted C₆-heteroalkyl wherein 1 carbon atom is replaced by an S, and 1 carbon atom is replaced by an N.

Each of R₂ or R₃ may be optionally substituted by one or more halogen, hydroxy, oxo, cyano, nitro, alkyl, alkoxy, haloalkyl, haloalkoxy, aryl-4-alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

Each of R₂ or R₃ may be optionally substituted by one or more C₁-C₆ alkyl. Each of R₂ or R₃ may be optionally substituted by one or more methyl, ethyl, propyl, butyl or pentyl.

Each of R₂ or R₃ may be optionally substituted by one or more oxo groups.

Each of R₂ or R₃ may be optionally substituted by one C₁-C₆ alkyl and one oxo group.

Each of R₂ or R₃ may be optionally substituted by one methyl group and one oxo group.

Each of R₂ or R₃ may be represented by Formula V:

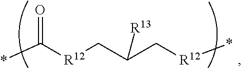

wherein R¹² is individually each O, S or N, and R¹³ is C₁₋₆ alkyl.

In Formula V, R¹³ may be methyl, ethyl, propyl, butyl, or pentyl.

R₂ₐ may be optionally substituted hetero-C₁₋₁₀-alkyl, wherein one or more chain carbon atoms is optionally replaced by a heteroatom.

R₂ may be an optionally substituted C₃, C₄, or C₅-heteroalkyl.

R₂ₐ may be an optionally substituted C₃-heteroalkyl wherein 1 carbon atom is replaced by an O. R₂ₐ may be an optionally substituted C₃-heteroalkyl wherein 1 carbon atom is replaced by an S. R₂ₐ may be an optionally substituted C₃-heteroalkyl wherein 1 carbon atom is replaced by an N.

R₂ₐ may be an optionally substituted C₃-heteroalkyl wherein 2 carbon atoms are replaced by an O, S or N. R₂ₐ may be an optionally substituted C₃-heteroalkyl wherein 2 carbon atoms are replaced by two O atoms. R₂ may be an optionally substituted C₃-heteroalkyl wherein 2 carbon atoms are replaced by two S atoms. R₂ may be an optionally substituted C₃-heteroalkyl wherein 2 carbon atoms are replaced by two N atoms. R₂ₐ may be an optionally substituted C₃-heteroalkyl wherein 1 carbon atom is replaced by an O, and 1 carbon atom is replaced by an S. R₂ may be an optionally substituted C₃-heteroalkyl wherein 1 carbon atom is replaced by an O, and 1 carbon atom is replaced by an N. R₂ₐ may be an optionally substituted C₃-heteroalkyl wherein 1 carbon atom is replaced by an S, and 1 carbon atom is replaced by an N.

R₂ₐ may be an optionally substituted C₄-heteroalkyl wherein 1 carbon atom is replaced by an O. R₂ₐ may be an optionally substituted C₄-heteroalkyl wherein 1 carbon atom is replaced by an S. R₂ₐ may be an optionally substituted C₄-heteroalkyl wherein 1 carbon atom is replaced by an N.

R₂ₐ may be an optionally substituted C₄-heteroalkyl wherein 2 carbon atoms are replaced by an O, S or N. R₂ may be an optionally substituted C₄-heteroalkyl wherein 2 carbon atoms are replaced by two O atoms. R₂ₐ may be an optionally C₄-heteroalkyl wherein 2 carbon atoms are replaced by two S atoms. R₂ₐ may be an optionally substituted C₄-heteroalkyl wherein 2 carbon atoms are replaced by two N atoms. R₂ₐ may be an optionally substituted C₄-heteroalkyl wherein 1 carbon atom is replaced by an O, and 1 carbon atom is replaced by an S. R₂ may be an optionally substituted C₄-heteroalkyl wherein 1 carbon atom is replaced by an O, and 1 carbon atom is replaced by an N. R₂ may be an optionally substituted C₄-heteroalkyl wherein 1 carbon atom is replaced by an S, and 1 carbon atom is replaced by an N.

R₂ₐ may be an optionally substituted C₅-heteroalkyl wherein 1 carbon atom is replaced by an O. R₂ₐ may be an optionally substituted C₅-heteroalkyl wherein 1 carbon atom is replaced by an S. R₂ₐ may be an optionally substituted C₅-heteroalkyl wherein 1 carbon atom is replaced by an N.

R₂ₐ may be an optionally substituted C₅-heteroalkyl wherein 2 carbon atoms are replaced by an O, S or N. R₂ₐ may be an optionally substituted C₅-heteroalkyl wherein 2 carbon atoms are replaced by two O atoms. R₂ₐ may be an optionally substituted C₅-heteroalkyl wherein 2 carbon atoms are replaced by two S atoms. R₂ₐ may be an optionally substituted C₅-heteroalkyl wherein 2 carbon atoms are replaced by two N atoms. R₂ₐ may be an optionally substituted C₅-heteroalkyl wherein 1 carbon atom is replaced by an O, and 1 carbon atom is replaced by an S. R₂ₐ may be an optionally substituted C₅-heteroalkyl wherein 1 carbon atom is replaced by an O, and 1 carbon atom is replaced by an N. R₂ₐ may be an optionally substituted C₅-heteroalkyl wherein 1 carbon atom is replaced by an S, and 1 carbon atom is replaced by an N.

R₂ₐ may be optionally substituted by one or more halogen, hydroxy, oxo, cyano, nitro, alkyl, alkoxy, haloalkyl, haloalkoxy, aryl-4-alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

R₂ₐ may be optionally substituted by one or more C₁-C₆ alkyl. R₂ₐ may be optionally substituted by one or more methyl, ethyl, propyl, butyl or pentyl.

R₂, may be optionally substituted by one or more oxo groups.

R₂ₐ may be represented by Formula VI:

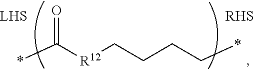

wherein R¹² is O, S or N, LHS indicates the point of attachment to R₂ and RHS indicates the point of attachment to R_{2b}.

Formula (I) may be represented by the structure:

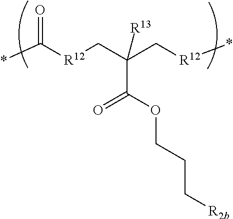

R₃ₐ may be optionally substituted hetero-C₁₋₁₀-alkyl, wherein one or more chain carbon atoms is optionally replaced by a heteroatom.

R₃ₐ may be an optionally substituted C₂, C₃ or C₄-heteroalkyl.

R₃ₐ may be an optionally substituted C₂-heteroalkyl wherein 1 carbon atom is replaced by an O. R₃ₐ may be an optionally substituted C₂-heteroalkyl wherein 1 carbon atom is replaced by an S. R₃ₐ may be an optionally substituted C₂-heteroalkyl wherein 1 carbon atom is replaced by an N.

R₃ₐ may be an optionally substituted C₃-heteroalkyl wherein 1 carbon atom is replaced by an O. R₃ₐ may be an optionally substituted C₃-heteroalkyl wherein 1 carbon atom is replaced by an S. R₃ₐ may be an optionally substituted C₃-heteroalkyl wherein 1 carbon atom is replaced by an N.

R₃ₐ may be an optionally substituted C₄-heteroalkyl wherein 1 carbon atom is replaced by an O. R₃ₐ may be an optionally substituted C₄-heteroalkyl wherein 1 carbon atom is replaced by an S. R₃ₐ may be an optionally substituted C₄-heteroalkyl wherein 1 carbon atom is replaced by an N.

R₃ₐ may be an optionally substituted C₄-heteroalkyl wherein 2 carbon atoms are replaced by an O, S or N. R₃ₐ may be an optionally substituted C₄-heteroalkyl wherein 2 carbon atoms are replaced by two O atoms. R₃ₐ may be an optionally C₄-heteroalkyl wherein 2 carbon atoms are replaced by two S atoms. R₃ₐ may be an optionally substituted C₄-heteroalkyl wherein 2 carbon atoms are replaced by two N atoms. R₃ₐ may be an optionally substituted C₄-heteroalkyl wherein 1 carbon atom is replaced by an O, and 1 carbon atom is replaced by an S. R₃ₐ may be an optionally substituted C₄-heteroalkyl wherein 1 carbon atom is replaced by an O, and 1 carbon atom is replaced by an N. R₃ₐ may be an optionally substituted C₄-heteroalkyl wherein 1 carbon atom is replaced by an S, and 1 carbon atom is replaced by an N.

R₃ₐ may be optionally substituted by one or more halogen, hydroxy, oxo, cyano, nitro, alkyl, alkoxy, haloalkyl, haloalkoxy, aryl-4-alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

R₃ₐ may be optionally substituted by one or more C₁-C₆ alkyl. R₃ₐ may be optionally substituted by one or more methyl, ethyl, propyl, butyl or pentyl.

R₃ₐ may be optionally substituted by one or more oxo groups.

R₃ₐ may be represented by Formula VII:

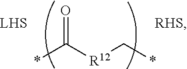

wherein R¹² is individually each O, S or N, LHS indicates the point of attachment to R₃ and RHS indicates the point of attachment to R_{3b}.

Formula (II) may be represented by the structure:

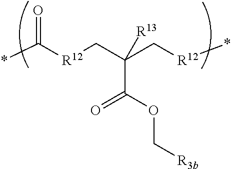

R_{2b} may comprise or consist of an anchoring moiety. The anchoring moiety may be an atomic or molecular group that is capable of forming covalent bonds between the disclosed copolymer and a chosen substrate. The anchoring moiety may comprise unsaturated bonds, for example, vinyl, allyl, acryl, or methacryl groups; lactones; aldehydes; epoxides; halogen anhydrides; alkyl halogens; or α-β-unsaturated carbonyl group, for example, maleic acid, maleamic acid and maleimide groups.

R_{2b} may be represented by Formulas VIIIa, VIIIb and VIIIc:

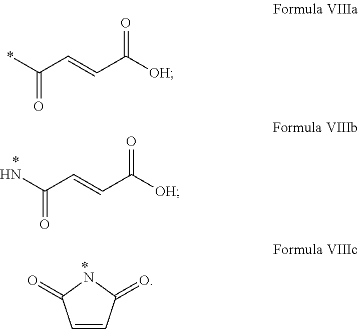 [SMILES: *C(=O)/C=C/C(=O)O ; NC(=O)/C=C/C(=O)O ; O=C1C=CC(=O)N1]

Formula (I) may be represented by the following structures:

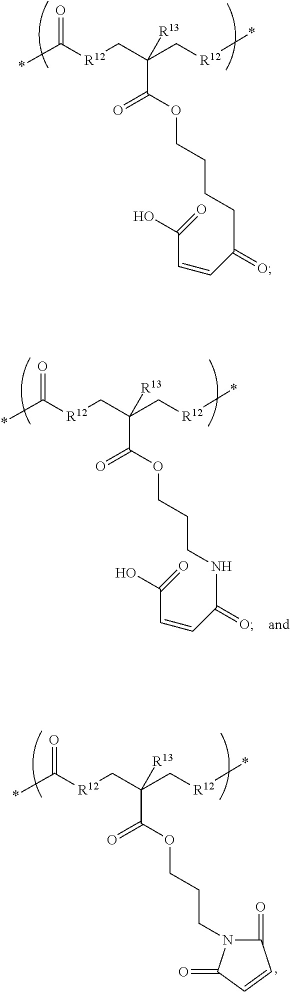

wherein R¹² and R¹³ are as defined above.

R_{3b} may comprise or consist of an antibacterial moiety. R_{3b} may be a molecular group that is capable of inhibiting the attachment and/or growth of a bacteria and/or microorganism. The antibacterial moiety may comprise a cation, antibiotics or silver ions. The antibacterial moiety may comprise a quaternary ammonium group.

R_{3b} may be represented by Formula IX:

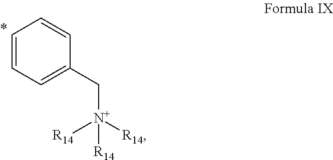

wherein each R₁₄ is independently an optionally substituted C₁ to C₁₂ alkyl group or a C₁ to C₁₂ alkaryl group. R₁₄ may be substituted with an aryl group. R₁₄ may be substituted with a phenyl group.

Formula IX may be of Formulas IXa, IXb, IXc or IXd:

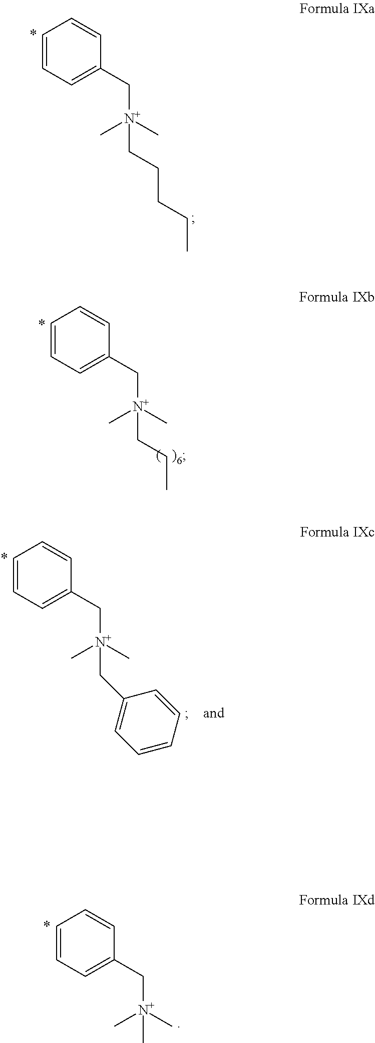

The copolymer (CP) may be a diblock copolymer, wherein one block consists of R₁, and the other block consists of repeating units of Formula (I).

The copolymer (CP) may be a diblock copolymer, wherein one block consists of R₁, and the other block consists of randomly arranged monomer units of Formulas (I) and (II).

The copolymer (CP) may be a triblock copolymer, wherein one block consists of R₁, the second block consists of Formula (I), and the third block consists of Formula (II).

The copolymer (CP) may be a triblock copolymer, wherein one block consists of R₁, the second block consists of Formula (II), and the third block consists of Formula (I).

Formula (I) may also be represented by the Formula (IA):

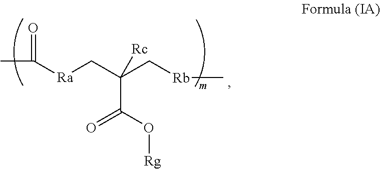

wherein m and n are as defined above,
   Rₐ, R_{b}, R_{c}, R_{d}, Rₑ and R_{f} are independently C(R₅)₂, O or N(R₅);
      R₅ is H, optionally substituted alkyl, optionally substituted alkenyl, optionally substituted alkynyl, optionally substituted aryl, optionally substituted heteroaryl, optionally substituted carbocycle, or optionally substituted heterocarbocycle; and
   R_{g} comprises an anchoring moiety.

R₅ may be optionally substituted C₁ to C₁₀ alkyl. R₅ may be optionally substituted methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, undecyl, or dodecyl.

R₅ may be optionally substituted C₂ to C₁₂ alkenyl. R₅ may be optionally substituted ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, or 1,5-hexadienyl.

R₅ may be optionally substituted C₂ to C₁₂ alkynyl. R₅ may be optionally substituted ethynyl, propynyl, 1-butynyl, 2-butynyl, 1-pentynyl, 2-pentynyl, 1-hexynyl, 2-hexynyl, 3-hexynyl, or 3-methyl-1-pentynyl.

R₅ may be optionally substituted C₆ to C₁₀ aryl. R₅ may be optionally substituted phenyl, biphenyl, naphthyl, or phenanthrenyl.

R₅ may be optionally substituted C₅ to C₁₄ heteroaryl. R₅ may be an optionally substituted aromatic monocyclic or a multicyclic ring system comprising about 5 to about 14 ring atoms in which one or more of the ring atoms is an element other than carbon, for example nitrogen, oxygen or sulfur, alone or in combination. R₅ may be optionally substituted pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl, tetrahydroisoquinolyl, or tetrahydroquinolyl.

R₅ may be optionally substituted C₃ to C₁₃ monocyclic, bicyclic or tricyclic ring, any of which may be saturated, partially unsaturated, or aromatic. R₅ may be cyclopropyl, cyclobutyl, cyclopentyl, cyclohexyl, cycloheptyl, adamantyl, cyclooctyl, [3.3.0]bicyclooctane, [4.3.0]bicyclononane, [4.4.0]bicyclodecane (decalin), [2.2.2]bicyclooctane, fluorenyl, phenyl, naphthyl, indanyl, adamantyl, or tetrahydronaphthyl (tetralin).

R_{g} may comprise or consist of an anchoring moiety. The anchoring moiety may be an atomic or molecular group that is capable of forming covalent bonds between the disclosed copolymer and a chosen substrate. The anchoring moiety may comprise unsaturated bonds, for example, vinyl, allyl, acryl, or methacryl groups; lactones; aldehydes; epoxides; halogen anhydrides; alkyl halogens; or α-β-unsaturated carbonyl group, for example, maleic acid, maleamic acid and maleimide groups.

R_{g} may be optionally substituted by one or more halogen, hydroxy, oxo, cyano, nitro, alkyl, alkoxy, haloalkyl, haloalkoxy, aryl-4-alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

### R_{g} may be of Formula (i):

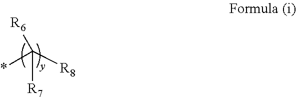 [0145] wherein * is the point of attachment;
   R₆ and R₇ are independently H, optionally substituted alkyl, optionally substituted alkenyl, optionally substituted alkynyl, optionally substituted aryl, optionally substituted heteroaryl, optionally substituted carbocycle, or optionally substituted heterocarbocycle;
   R₈ is an anchoring moiety comprising a α-β-unsaturated carbonyl group; and
   y is an integer in the range of 1 to 5.

R₆ and R₇ may be independently optionally substituted C₁ to C₁₀ alkyl. R₆ and R₇ may be optionally substituted methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, undecyl, or dodecyl.

R₆ and R₇ may be independently optionally substituted C₂ to C₁₂ alkenyl. R₆ and R₇ may be optionally substituted ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, or 1,5-hexadienyl.

R₆ and R₇ may be independently optionally substituted C₂ to C₁₂ alkynyl. R₆ and R₇ may be optionally substituted ethynyl, propynyl, 1-butynyl, 2-butynyl, 1-pentynyl, 2-pentynyl, 1-hexynyl, 2-hexynyl, 3-hexynyl, or 3-methyl-1-pentynyl.

R₆ and R₇ may be independently optionally substituted C₆ to C₁₀ aryl. R₆ and R₇ may be optionally substituted phenyl, biphenyl, naphthyl, or phenanthrenyl.

R₆ and R₇ may be independently optionally substituted C₅ to C₁₄ heteroaryl. R₆ and R₇ may be an optionally substituted aromatic monocyclic or a multicyclic ring system comprising about 5 to about 14 ring atoms in which one or more of the ring atoms is an element other than carbon, for example nitrogen, oxygen or sulfur, alone or in combination. R₅ may be optionally substituted pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl, tetrahydroisoquinolyl, or tetrahydroquinolyl.

R₆ and R₇ may be independently C₃ to C₁₃ monocyclic, bicyclic or tricyclic ring, any of which may be saturated, partially unsaturated, or aromatic. R₆ and R₇ may be cyclopropyl, cyclobutyl, cyclopentyl, cyclohexyl, cycloheptyl, adamantyl, cyclooctyl, [3.3.0]bicyclooctane, [4.3.0]bicyclononane, [4.4.0]bicyclodecane (decalin), [2.2.2]bicyclooctane, fluorenyl, phenyl, naphthyl, indanyl, adamantyl, or tetrahydronaphthyl (tetralin).

R₆ and R₇ may be independently optionally substituted by one or more halogen, hydroxy, oxo, cyano, nitro, alkyl, alkoxy, haloalkyl, haloalkoxy, aryl-4-alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

R₈ may comprise vinyl, allyl, acryl, or methacryl groups; lactones; aldehydes; epoxides; halogen anhydrides; alkyl halogens; or α-β-unsaturated carbonyl group, for example, maleic acid, maleamic acid and maleimide groups.

R₈ may be represented by Formulas VIIIa, VIIIb and VIIIc:

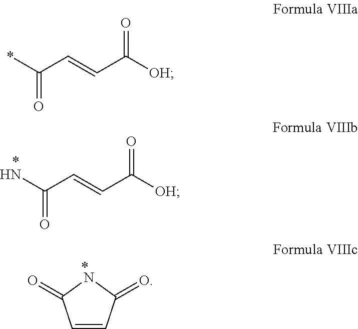 [SMILES: *C(=O)/C=C/C(=O)O ; NC(=O)/C=C/C(=O)O ; O=C1C=CC(=O)N1]

Formula (I) may be of Formula (IB):

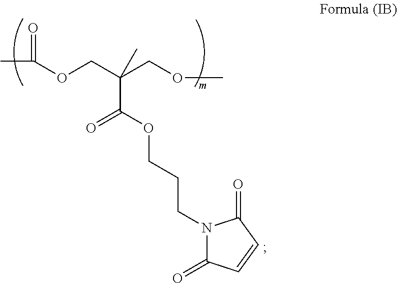

wherein m is as defined above.

Formula (II) may also be represented by the Formula (IIA):

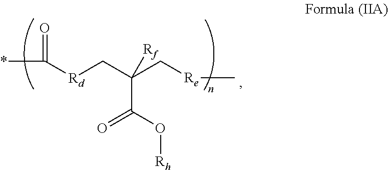

wherein m and n are as defined above,
   Rₐ, R_{b}, R_{c}, R_{d}, Rₑ and R_{f} are independently C(R₅)₂, O or N(R₅);
      R₅ is H, optionally substituted alkyl, optionally substituted alkenyl, optionally substituted alkynyl, optionally substituted aryl, optionally substituted heteroaryl, optionally substituted carbocycle, or optionally substituted heterocarbocycle; and
   Rₕ comprises an antibacterial moiety.

R₅ may be optionally substituted C₁ to C₁₀ alkyl. R₅ may be optionally substituted methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, undecyl, or dodecyl.

R₅ may be optionally substituted C₂ to C₁₂ alkenyl. R₅ may be optionally substituted ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, or 1,5-hexadienyl.

R₅ may be optionally substituted C₂ to C₁₂ alkynyl. R₅ may be optionally substituted ethynyl, propynyl, 1-butynyl, 2-butynyl, 1-pentynyl, 2-pentynyl, 1-hexynyl, 2-hexynyl, 3-hexynyl, or 3-methyl-1-pentynyl.

R₅ may be optionally substituted C₆ to C₁₀ aryl. R₅ may be optionally substituted phenyl, biphenyl, naphthyl, or phenanthrenyl.

R₅ may be optionally substituted C₅ to C₁₄ heteroaryl. R₅ may be an optionally substituted aromatic monocyclic or a multicyclic ring system comprising about 5 to about 14 ring atoms in which one or more of the ring atoms is an element other than carbon, for example nitrogen, oxygen or sulfur, alone or in combination. R₅ may be optionally substituted pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl, tetrahydroisoquinolyl, or tetrahydroquinolyl.

R₅ may be optionally substituted C₃ to C₁₃ monocyclic, bicyclic or tricyclic ring, any of which may be saturated, partially unsaturated, or aromatic. R₅ may be cyclopropyl, cyclobutyl, cyclopentyl, cyclohexyl, cycloheptyl, adamantyl, cyclooctyl, [3.3.0]bicyclooctane, [4.3.0]bicyclononane, [4.4.0]bicyclodecane (decalin), [2.2.2]bicyclooctane, fluorenyl, phenyl, naphthyl, indanyl, adamantyl, or tetrahydronaphthyl (tetralin).

R₅ may be optionally substituted by one or more halogen, hydroxy, oxo, cyano, nitro, alkyl, alkoxy, haloalkyl, haloalkoxy, aryl-4-alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

Rₕ may comprise or consist of an antibacterial moiety. Rₕ may be a molecular group that is capable of inhibiting the attachment and/or growth of a bacteria and/or microorganism. The antibacterial moiety may comprise a cation, antibiotics or silver ions. The antibacterial moiety may comprise a quaternary ammonium group.

Rₕ may be of Formula (ii):

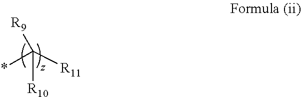

wherein R₉ and R₁₀ are independently H, optionally substituted alkyl optionally substituted alkenyl, optionally substituted alkynyl, optionally substituted aryl, optionally substituted heteroaryl, optionally substituted carbocycle, or optionally substituted heterocarbocycle;
R₁₁ is an aryl or heteroaryl substituted with at least one cation; and
z is an integer in the range of 1 to 5.

R₉ and R₁₀ may be independently optionally substituted C₁ to C₁₀ alkyl. R₉ and R₁₀ may be optionally substituted methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, undecyl, or dodecyl.

R₉ and R₁₀ may be independently optionally substituted C₂ to C₁₂ alkenyl. R₉ and R₁₀ may be optionally substituted ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, or 1,5-hexadienyl.

R₉ and R₁₀ may be independently optionally substituted C₂ to C₁₂ alkynyl. R₉ and R₁₀ may be optionally substituted ethynyl, propynyl, 1-butynyl, 2-butynyl, 1-pentynyl, 2-pentynyl, 1-hexynyl, 2-hexynyl, 3-hexynyl, or 3-methyl-1-pentynyl.

R₉ and R₁₀ may be independently optionally substituted C₆ to C₁₀ aryl. R₉ and R₁₀ may be optionally substituted phenyl, biphenyl, naphthyl, or phenanthrenyl.

R₉ and R₁₀ may be independently optionally substituted C₅ to C₁₄ heteroaryl. R₉ and R₁₀ may be an optionally substituted aromatic monocyclic or a multicyclic ring system comprising about 5 to about 14 ring atoms in which one or more of the ring atoms is an element other than carbon, for example nitrogen, oxygen or sulfur, alone or in combination. R₉ and R₁₀ may be optionally substituted pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl, tetrahydroisoquinolyl, or tetrahydroquinolyl.

R₉ and R₁₀ may be independently C₃ to C₁₃ monocyclic, bicyclic or tricyclic ring, any of which may be saturated, partially unsaturated, or aromatic. R₉ and R₁₀ may be cyclopropyl, cyclobutyl, cyclopentyl, cyclohexyl, cycloheptyl, adamantyl, cyclooctyl, [3.3.0]bicyclooctane, [4.3.0]bicyclononane, [4.4.0]bicyclodecane (decalin), [2.2.2]bicyclooctane, fluorenyl, phenyl, naphthyl, indanyl, adamantyl, or tetrahydronaphthyl (tetralin).

R₉ and R₁₀ may be independently optionally substituted by one or more halogen, hydroxy, oxo, cyano, nitro, alkyl, alkoxy, haloalkyl, haloalkoxy, aryl-4-alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

R₁₁ may be an aryl or heteroaryl substituted with at least one cation.

R₁₁ may be optionally substituted C₆ to C₁₀ aryl. R₁ may be optionally substituted phenyl, biphenyl, naphthyl, or phenanthrenyl.

R₁₁ may be independently optionally substituted C₅ to C₁₄ heteroaryl. R₁₁ may be an optionally substituted aromatic monocyclic or a multicyclic ring system comprising about 5 to about 14 ring atoms in which one or more of the ring atoms is an element other than carbon, for example nitrogen, oxygen or sulfur, alone or in combination. R₁₁ may be optionally substituted pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl, tetrahydroisoquinolyl, or tetrahydroquinolyl.

R₁₁ may be optionally substituted by one or more halogen, hydroxy, oxo, cyano, nitro, alkyl, alkoxy, haloalkyl, haloalkoxy, aryl-4-alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl.

R₁₁ may be represented by Formula IX:

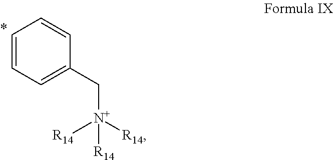

wherein each R₁₄ is independently an optionally substituted C₁ to C₁₂ alkyl group. R₁₄ may be substituted with an aryl group. R₁₄ may be substituted with a phenyl group.

R₁₁ may be of Formulas IXa, IXb, IXc or IXd:

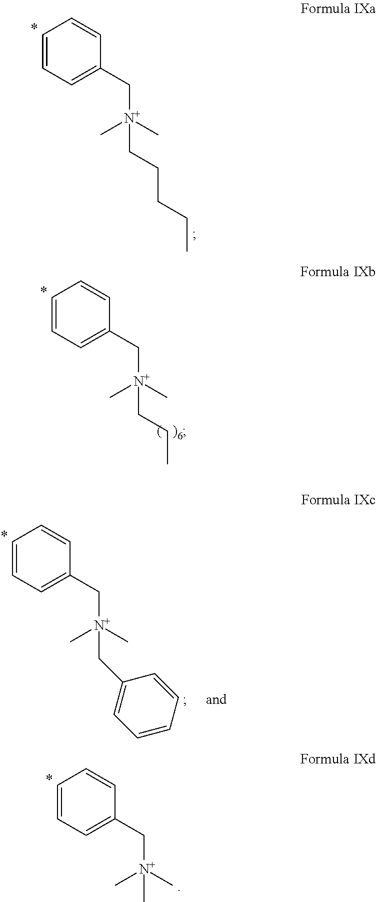

Formula (II) may be selected from the group consisting of:

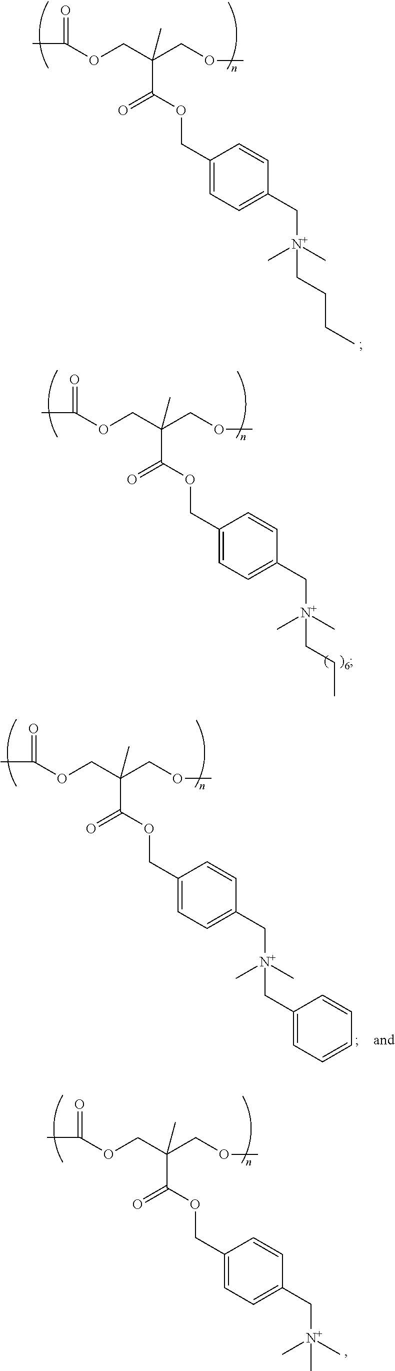

wherein n is as defined above.

The copolymer (CP) may be selected from the group consisting of:

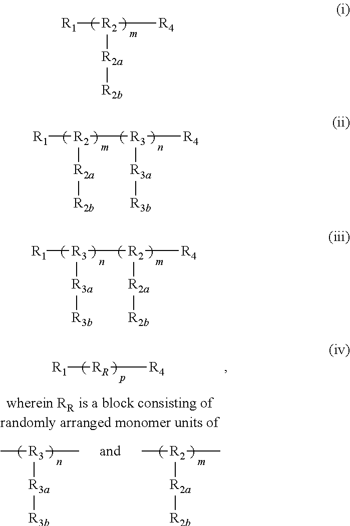

wherein R₁, R₂, R₃, R₄, R₂ₐ, R_{2b}, R₃ₐ, R_{3b}, m and n are as defined above, and p is an integer in the range of 1 to 10.
p is an integer in the range of 1 to 50.
p may be an integer in the range of 1 to 50, or 1 to 40, or 1 to 30, or 1 to 20, or 1 to 10, or 10 to 50, or 20 to 50, or 30 to 50, or 40 to 50, or p is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

The present disclosure also provides for a method of synthesizing a copolymer (CPᵢₙₜ) comprising monomer units represented by formulas (IIIA) and/or (IIIB):

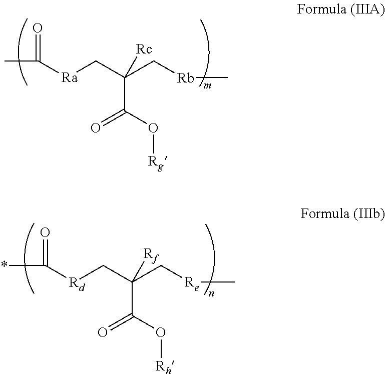

wherein the copolymer is terminated on one end by R₁ and on the other end by R₄;
   R₁ is a polymer residue comprising an antifouling moiety,
   R₄ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
   Rₐ, R_{b}, R_{c}, R_{d}, Rₑ and R_{f} are independently C(R₅)₂, O or N(R₅);
      R₅ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
   R_{g}′ represents protected R_{g}, and Rₕ′ represents aryl or heteroaryl substituted with at least one substituent capable of being quaternized,
      wherein R_{g} comprises an anchoring moiety;
   m is an integer in the range of 1 to 20; and
   n is an integer in the range of 0 to 100,
the method comprising the step of:
(ii) performing a ring-opening polymerization reaction in a reaction mixture comprising compounds of Formula (IC), H—R₁, and compounds of Formula (IIC):

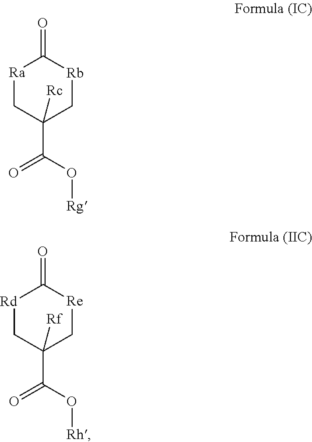

with the proviso that compounds of Formula (IIC) are present only when n≠0,
thereby forming a copolymer (CPᵢₙₜ) comprising monomer units of Formula (IIIA) and/or (IIIB).

The copolymer (CPᵢₙₜ) may be selected from the group consisting of:

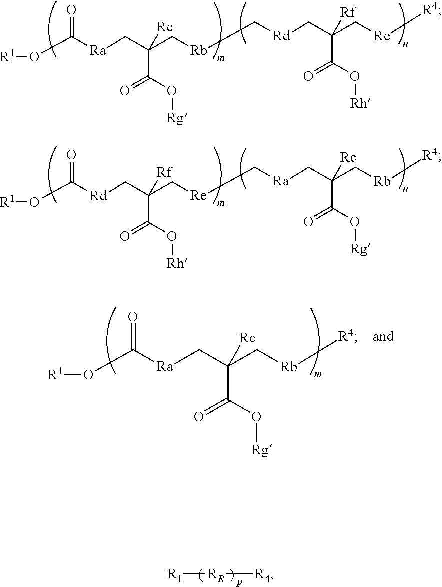

wherein Ra, Rb, Rc, Rd, Re, Rf, Rg, Rh, Rg′, Rh′, R₁, R₄, m, n and p are as defined above, R_{R} is a block consisting of randomly arranged monomer units of

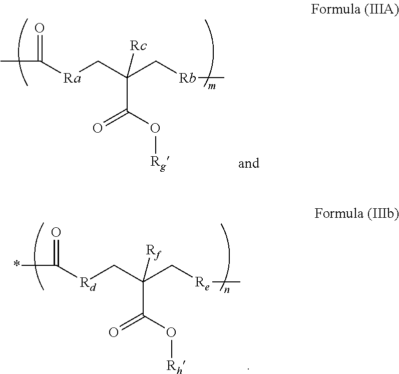

The method of synthesizing the copolymer (CPᵢₙₜ) may further comprise the following steps:
(ii) performing a deprotection reaction on the copolymer formed in claim 27, thereby exposing the R_{g} anchoring moiety(s); and
(iii) when n≠0, performing a quaternization reaction,

thereby forming a copolymer (CP) comprising monomer units represented by formulas (IA) and/or (IIA):

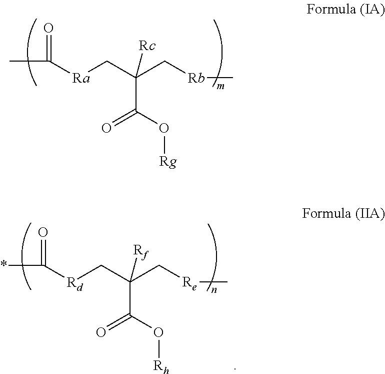

Step (i) of the above method may further comprise a ring opening polymerization catalyst. The ring-opening polymerization catalyst may be selected from the group consisting of 1,8-diazabicyclo[5.4.0]undec-7-ene (DBU), tin(II) 2-ethylhexanoate (Sn(Oct)₂) and tin(II) trifluoromethanesulfonate (Sn(OTf)₂). The deprotection may be carried out by dissolving the copolymer formed in step (i) in toluene.

H—R₁ may be selected from the group consisting of poly(ethylene glycol) (PEG), methoxypoly(ethylene glycol) (mPEG), poly(methoxyethyl methacrylate) and poly(ethoxyethyl methacrylate).

The quaternization reagent may be selected from the group consisting of amine, dimethylbutylamine, dimethyloctylamine, dimethylbenzylamine, and trimethylamine.

The present disclosure also provides a method of attaching a copolymer (CP) to a substrate, comprising attaching the anchoring moiety of said copolymer to an anchoring segment on said substrate. The anchoring moiety may comprise one or more thiol groups. The copolymer may be attached to the substrate via a Micahel addition.

The present disclosure also provides a substrate and a coating comprising a copolymer (CP) disclosed herein.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 shows the general process of a polymer coating process with triblock copolymers of PEG, cationic polycarbonate (CPC) and maleimide-functionalized polycarbonate (PMC).

FIG. 2 shows the general process of a polymer coating process with diblock copolymers of PEG and cationic polycarbonate containing maleimide groups (i.e. 2.4 k-MC and 10 k-MC) and copolymers of PEG and maleimide-functionalized polycarbonate (i.e. 2.4 k-M and 10 k-M).

FIG. 3 shows a graph of viable surface colonies analysis of S. aureus (S.a.) and E. coli (E.c) at 1 and 7 days on pristine, thiol-functionalized and surfaces coated with triblock copolymers of PEG, cationic polycarbonate (CPC) and maleimide-functionalized polycarbonate (PMC).

FIG. 4 shows a graph of viable surface colonies analysis of S. aureus and E. coli at 1 and 7 days on pristine, thiol-functionalized and surfaces coated with diblock copolymers of PEG and cationic polycarbonate containing maleimide groups (i.e. 2.4 k-MC and 10 k-MC) and copolymers of PEG and maleimide-functionalized polycarbonate (i.e. 2.4 k-M and 10 k-M).

FIG. 5a is a ¹H spectra of protected polymer 2.4 k-V.

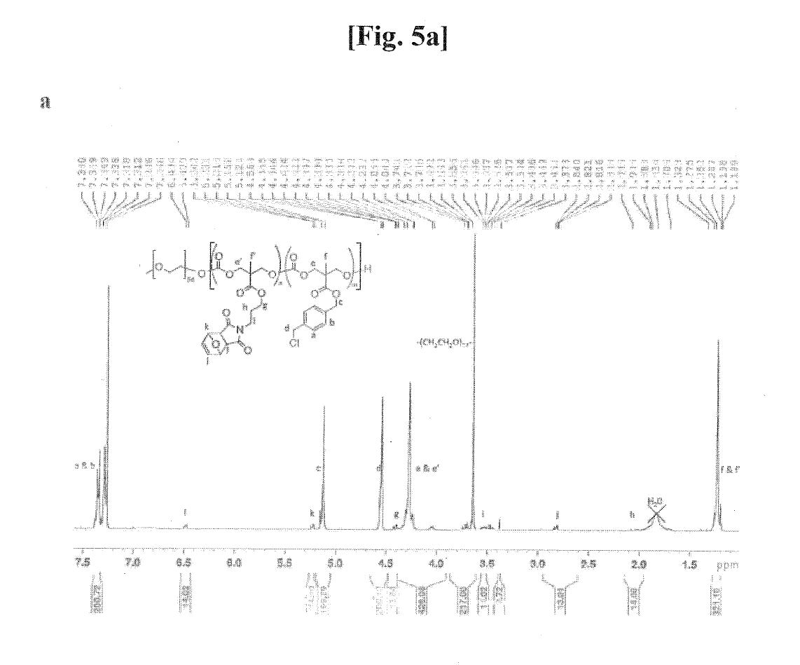

FIG. 5b is a ¹H spectra of deprotected polymer 2.4 k-V.

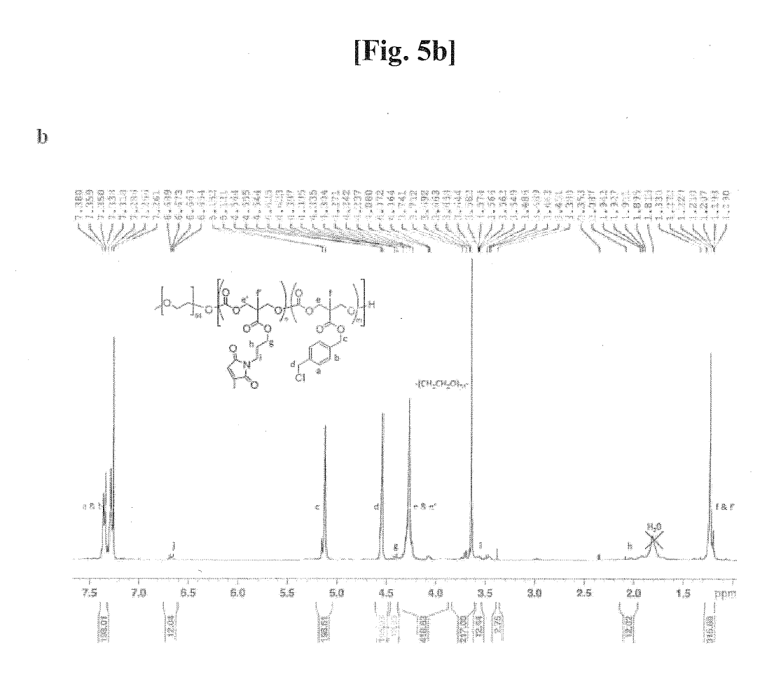

FIG. 5c is a ¹H spectra of quarternized polymer 2.4 k-V.

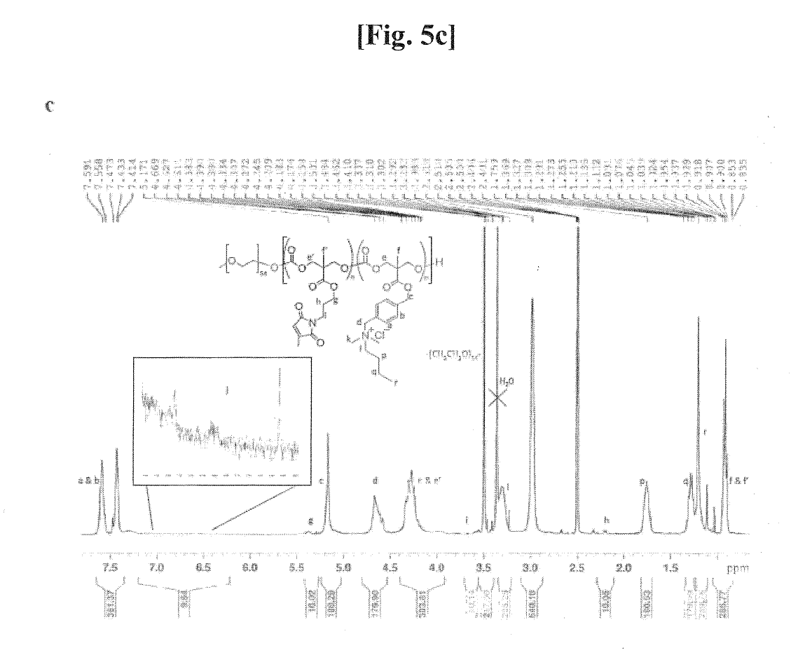

FIG. 6 is a depiction of static water contact angles of a pristine surface, a thio-functionalized surface, a 2.4 k-V coated surface and a 2.4 k-S coated surface.

FIG. 7 is a graph showing the antibacterial activity of pristine, thiol-functionalized silicone rubber surfaces and surfaces coated with the disclosed polymers against (a) Gram-positive S. aureus; and (b) Gram-negative E. coli.

FIG. 8 is a graph showing the metabolic activity of (a) S. aureus; and (b) E. coli fouling on pristine, thiol-functionalized surfaces and surfaces coated with the disclosed polymers with various treatments by (a) XTT; and (b) Cell Titer-Blue® Assay analyses.

FIG. 9 shows a study of protein fouling on uncoated and coated PDMS surfaces via observation of BSA-FITC using spectroscopy, showing prevention of protein fouling.

FIG. 10 is a graph showing hemolysis data for rat red blood cells incubated with various polymer coated PDMS surfaces.

FIG. 11a is a ¹H NMR spectra of protected polymer 2.4 k-MC. FIG. 11b

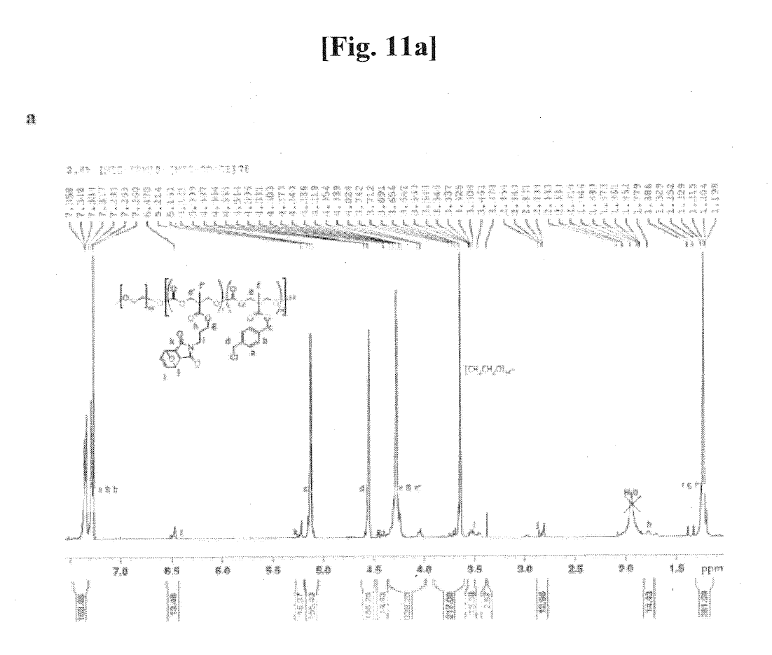

FIG. 11b is a ¹H NMR spectra of deprotected polymer 2.4 k-MC.

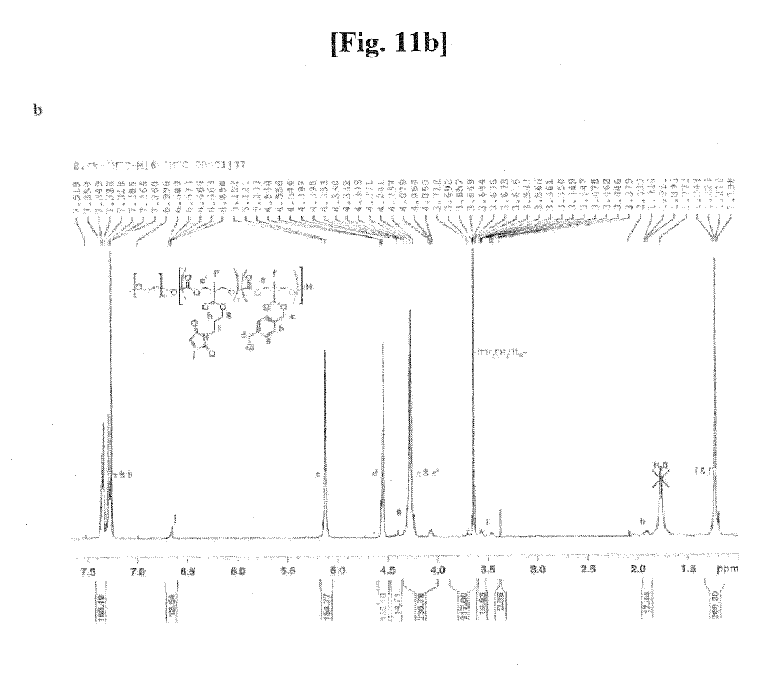

FIG. 11c is a ¹H NMR spectra of quaternized polymer 2.4 k-M.

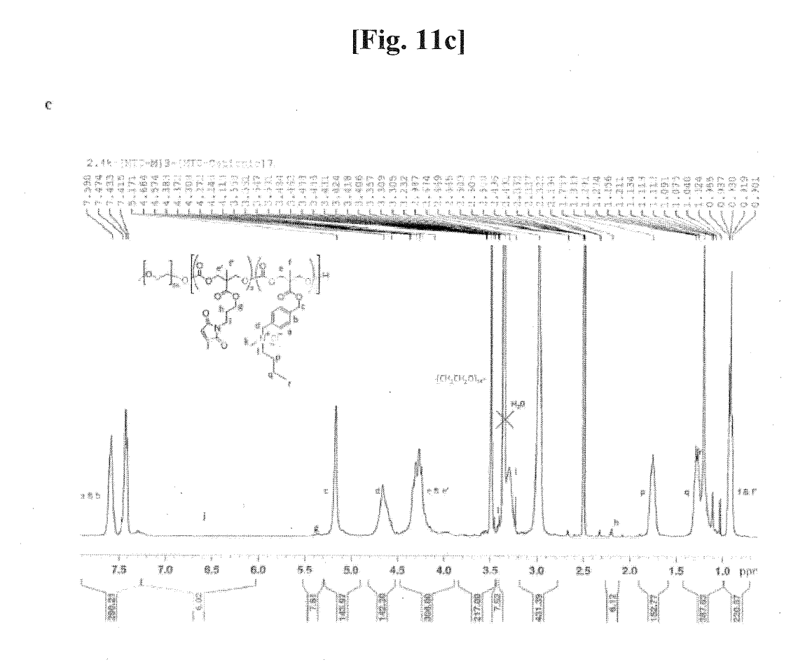

FIG. 12a is a ¹H NMR spectra of protected non-cationic polymer 2.4 k-M.

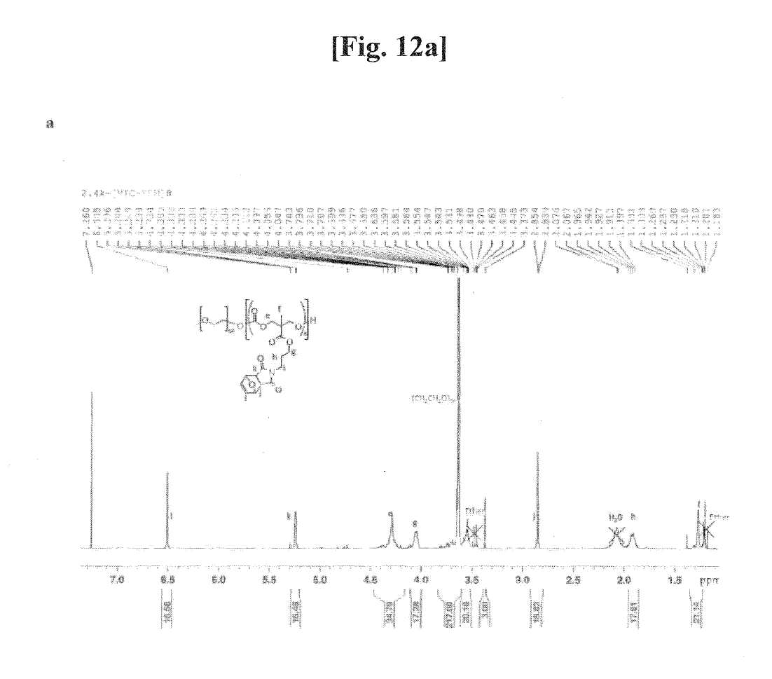

FIG. 12b is a ¹H NMR spectra of deprotected non-cationic polymer 2.4 k-M.

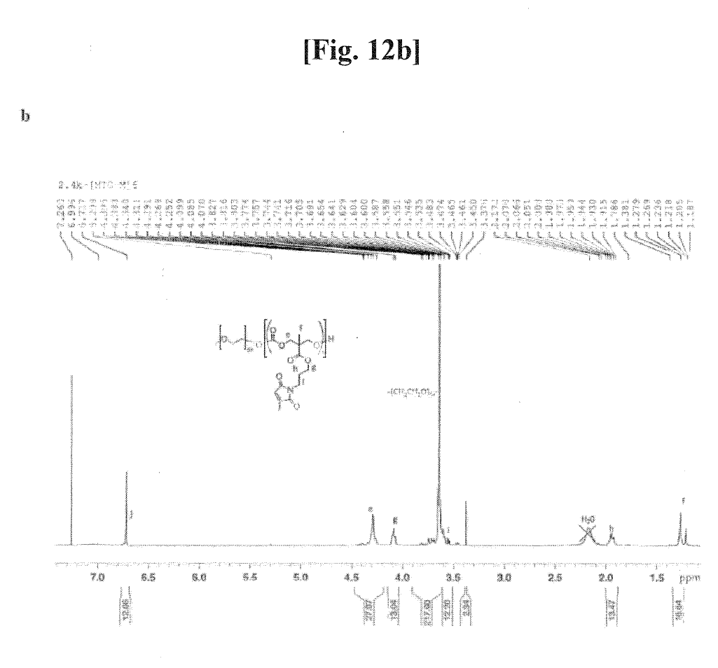

FIG. 13 is a depiction of static water contact angles of a pristine surface, a thio-functionalized surface, a 2.4 k-MC coated surface, a 10 k-MC coated surface, a 2.4 k-M coated surface, and a 10 k-M coated surface.

FIG. 14 is a N1s spectra of 2.4 k-MC and 2.4 k-M polymer-coated surfaces.

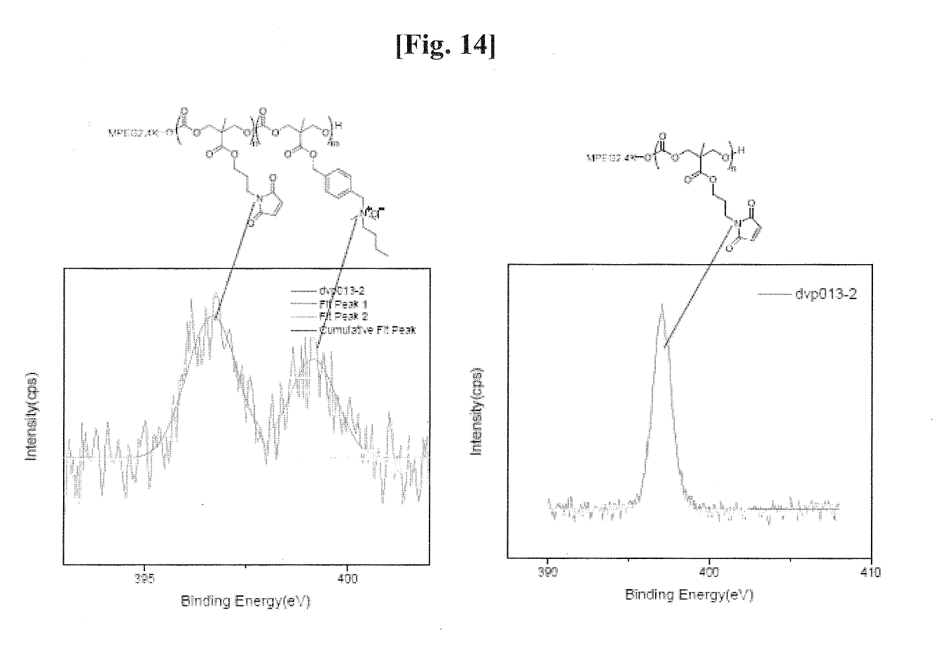

FIG. 15 is a graph showing the antibacterial activity of pristine, thiol-functionalized silicone rubber surfaces and surfaces coated with the disclosed polymers against (a) Gram-positive S. aureus (S.a); and (b) Gram-negative E. coli (E.c).

FIG. 16 is a graph showing the metabolic activity of (a) S. aureus; and (b) E. coli fouling on pristine, thiol-functionalized surfaces and surfaces coated with the disclosed polymers.

FIG. 17 shows a study of protein fouling on uncoated and coated PDMS surfaces via observation of BSA-FITC using spectroscopy, showing prevention of protein fouling.

FIG. 18 is a graph showing hemolysis data for rat red blood cells incubated with various polymer coated PDMS surfaces.

### EXAMPLES

Non-limiting examples of the invention will be further described in greater detail by reference to specific Examples, which should not be construed as in any way limiting the scope of the invention.

Materials CH₃O-PEG-OH (known as MPEG, Mn 2400 g·mol⁻¹, PDI 1.05) was purchased from Polymer Source™, lyophilized and transferred to a glove-box one day prior to use. N-(3,5-trifluoromethyl)phenyl-N′-cyclohexylthiourea (TU) was prepared according to a procedure described below. TU was dissolved in dry tetrahydrofuran and dried over CaH₂ overnight. The mixture was filtered, and the solvent removed in vacuo. 1,8-Diazabicyclo[5,4,0]undec-7-ene (DBU) was dried over CaH₂ overnight, and dried DBU was obtained after vacuum distillation. Both dried TU and DBU were transferred to a glove-box prior to use. FITC-conjugated bovine serum albumin (FITC-BSA), 3-mercaptopropyltrimethoxysilane and all other chemicals were purchased from Sigma-Aldrich, and used as received unless stated otherwise. Silicone Kit Sylgard 184 was bought from Dow Corning, and used according to the manufacturer's protocols. LIVE/DEAD Baclight bacterial viability kit (L-7012) was obtained from Invitrogen. S. aureus (ATCC No. 6538) and E. coli (ATC No. 25922) were purchased from ATCC (U.S.A).

### Experimental

### Preparation of N-(3, 5-trifluoromethyl)phenyl-N′-cyclohexylthiourea (TU)

Thiourea co-catalyst was synthesized via addition of cyclohexylamine (1.85 g, 18.5 mmol) dropwise at room temperature to a stirring solution of 3,5-bis(trifluoromethyl)phenyl isothiocyanate (5.0 g, 19 mmol) in tetrahydrofuran (THF) (20 mL). After stirring for 4 hours, the solvent was evaporated. The white residue was recrystallized from chloroform to give TU as a white powder. Yield: 5.90 g (86%). ¹H NMR (400 MHz, CDCl₃, 22° C.) δ: 7.52 (s, 1H, 5-ArH), 7.33 (s, 2H, 2,6-ArH), 6.50 (s, 1H, ArNH), 5.17 (s, 1H, CyNH), 4.40 (br m, 1H, NCyH), 2.03-0.86 (m, 10H, CyH).

Gel Permeation Chromatography (GPC):

Polymer molecular weights were analysed by GPC using a Waters HPLC system equipped with a 2690D separation module, two Styragel HR1 and HR4E (THF) 5 mm columns (size: 300×7.8 mm) in series arrangement, coupled with a Waters 410 differential refractometer detector. THF was employed as the mobile phase at a flow rate of 1 mL·min⁻¹. Number-average molecular weights, as well as polydispersity indices of polymers were calculated from a calibration curve based on a series of polystyrene standards with molecular weights ranging from 1350 to 151700.

1H NMR Analysis:

1H NMR spectra of monomers and polymers were recorded on a Bruker Advance 400 NMR spectrometer, operated at 400 MHz and at room temperature. The 1H NMR measurements were performed using an acquisition time of 3.2 s, a pulse repetition time of 2.0 s, a 300 pulse width, 5208-Hz spectral width, and 32 K data points. Chemical shifts were referred to solvent peaks (δ=7.26 and 1.94 ppm for CDCl₃ and CD₃CN-d₆, respectively).

Preparation of Polydimethylsiloxane (PDMS) Silicone Rubber:

PDMS silicone rubber was prepared by mixing 10 base parts to 1 curing part thoroughly, followed by degassing under vacuum for 30 min. The mixture was spin coated onto a Petri dish (for LIVE/DEAD cell staining and SEM studies) using SAWATECH AG Spin Module SM-180-BT, or it was cast into a 48-well plate for XTT, Titer Blue® cell viability and colony assays. Both the Petri dish and plate were placed overnight in a vacuum oven at 70° C. for curing. After curing, the PDMS sample formed in the Petri dish was cut into square pieces (0.5 cm×0.5 cm with a thickness of about 1 mm). The disc-like PDMS samples were gently removed from the bottom of the 48-well plate with flat forceps. All PDMS samples were first sonicated with de-ionized (DI) water, followed by isopropanol and DI water. The samples were dried under a stream of nitrogen before use.

Vapour Deposition of PDMS Surface:

Clean PDMS surface was exposed to ultraviolet/ozone (UVO) radiation for 1 hour in a commercial PSD-UVT chamber (Novascan). The surface was then briefly exposed to humid air, and dried under a stream of nitrogen. Subsequently, the dried PDMS surface was placed on a clean piece of weighing paper in a small vacuum desiccator, together with 1 mL of 3-mercaptopropyltrimethoxysilane loaded in a clean vial. The vapour deposition process was carried out overnight with the desiccator sealed under vacuum at 70° C. to provide thiol-functionalized surface. The treated surface was dried under a stream of nitrogen, and kept in a sealed desiccator at room temperature prior to use.

Polymer Coating:

The polymers of different composition (2 mg) were first dissolved in 400 μL of HPLC grade water, 500 μL of PBS (pH 7.4), and 100 μL of SDS solution. Subsequently, the clean PDMS surface treated with 3-mercaptopropyltrimethoxysilane was immersed in the polymer solution for 1 day at room temperature (˜22° C.). The polymer-coated PDMS samples were sonicated in a mixture of isopropropanol and water (1:1 volume ratio), and dried under a stream of nitrogen before further use or characterization.

X-Ray Photoelectron Spectroscopy (XPS) Measurements:

The difference in chemistry between uncoated and polymer-coated PDMS surfaces was analyzed by X-ray photoelectron spectroscopy (XPS, Kratos Axis HSi, Kratos Analytical, Shimadzu, Japan) with Al Ka source (hν=1486.71 eV). The angle between the surface of the sample and the detector was kept at 90°. The survey spectrum (from 1100 to 0 eV) was acquired with pass energy of 80 eV. All binding energies were calculated with reference to C 1s (C—C bond) at 284.5 eV.

Static Contact Angle Measurements:

The static contact angles of both uncoated and polymercoated surfaces were measured by an OCA15 contact angle measuring device (Future Digital Scientific Corp., U.S.A.). DI water (20 μL) was used for all measurements. All samples were analyzed in triplicates, and the static contact angle data were presented as mean±SD.

Killing Efficiency of Polymer-Coated Surfaces (Colony Assay):

The concentration of S. aureus or E. coli in Mueller-Hinton broth (MHB, cation-adjusted) was adjusted to give an initial optical density (O.D.) reading of 0.07 at the wavelength of 600 nm on a microplate reader (TECAN, Switzerland), which correlates to a concentration of Mc Farland 1 solution (3×10⁸ CFU·mL⁻¹). The bacterial solution was diluted by 1000 times to achieve a loading of 3×10⁵ CFU·mL⁻¹. Subsequently, 20 μL of this bacterial solution was added to the surface of an uncoated or coated disc-like PDMS sample, which was placed in a 48-well plate. Additionally, 60 μL of MHB was added to the surface, and the 48-well plate was incubated at 37° C. for 24 hours. The bacterial solution (10 μL) was then taken out from each well and diluted with an appropriate dilution factor. The bacterial solution was streaked onto an agar plate (LB Agar from 1st Base). The number of colony-forming units (CFUs) was tabulated and recorded after an incubation of about 18 hours at 37° C. Each test was conducted in triplicates.

Antifouling Analysis of Pristine, Thiol-Functionalized and Polymer-Coated PDMS Surfaces by Surface Viable Colonies:

Quantitative measurement of live S. aureus cells attached onto PDMS surface was performed by directly enumerating the bacteria adhering to the surface. Briefly, S. aureus or E. coli in MHB (20 μL, 3×105 CFU·mL⁻¹) was seeded onto uncoated and polymercoated PDMS surfaces, topped up with 60 μL of MHB, and cultured at 37° C. for 24 hours. Each surface was washed thrice with sterile PBS, and was carefully placed in individual 8-ml tube containing 1.5 ml PBS. Each tube was sonicated for 8 sec and viable counts in the resulting suspensions was performed by plating on agar medium to enumerate bacteria that were attached to the disc-like PDMS surface.

Antifouling Analysis of Uncoated and Polymer-Coated PDMS Surfaces by XTT Assay:

Another quantitative measurement of live bacteria cells attached onto the disc-like PDMS surface was performed by studying 2,3-bis (2-methoxy-4-nitro-5-sulfo-phenyl)-2H-tetrazolium-5-carboxanilide (XTT) reduction.[2] XTT reduction assay measures the mitochondrial enzyme activity in live cells. The optical density (O.D.) of formazan dye produced by XTT reduction within mitochondrial enzymes of viable cells was recorded, and the experiment was conducted in triplicates. Briefly, S. aureus in MHB (20 μL, 3×10⁵ CFU·mL⁻¹) was seeded onto uncoated and polymer-coated PDMS surfaces, topped up with 60 μL of MHB, and cultured at 37° C. for 24 hours. Each surface was washed thrice with sterile PBS, followed by incubation with 100 mL of PBS, 10 μL of XTT and 5 μL of menadione at 37° C. for 2 hours. The mitochondrial dehydrogenase of the bacterial cells reduced XTT tetrazolium salt to formazan, and the colorimetric change was correlated to cell metabolic activity (cell viability). The absorbance of each sample was measured at 490 nm with a reference wavelength of 660 nm using a microplate reader (TECAN, Sweden).

Antifouling Analysis of Uncoated and Polymer-Coated PDMS Surfaces by Cell Titer Blue® Assay:

The Cell Titer-Blue® cell viability assay provided quantitative analysis of live E. coli cells attached onto the disc-like PDMS surface. The fluorescence intensity of resorufin produced after reduction within mitochondrial enzymes of viable cells was recorded, and the experiment was conducted in triplicates. E. coli in MHB (20 μL, 3×10⁵ CFU·mL⁻¹) was seeded onto the uncoated and polymer-coated PDMS surfaces, topped up with 60 μL of MHB, and cultured at 37° C. for 24 hours. The surface was washed twice with sterile PBS, followed by incubation with 100 mL of PBS and 20 μL of Cell Titer Blue Reagent at 37° C. for 2 hours. The fluorescence intensity readings of the wells were determined at excitation wavelength of 560 nm and emission wavelength of 590 nm using the microplate reader.

LIVE/DEAD Baclight Bacterial Viability Assay:

A LIVE/DEAD Baclight bacterial viability kit (L-7012, Invitrogen), containing both propidium iodide and SYTO® fluorescent nucleic acid staining agents, was used to label bacterial cells on the uncoated and polymer-coated PDMS surfaces. Briefly, the red-fluorescent nucleic acid staining agent propidium iodide, which only penetrates damaged cell membrane, was used to label dead bacterial cells. SYTO® 9 greenfluorescent nucleic acid staining agent, which can penetrate cells both with intact and damaged membranes, was used to label all bacterial cells. Bacteria solution (3×10⁵ CFU·mL⁻¹, 20 μL) was seeded onto the uncoated and polymer-coated PDMS surfaces, followed by incubation at 37° C. for 24 hours or 7 days. The surfaces were washed thrice with clean PBS after the bacteria solution was removed. Subsequently, each PDMS sample was placed individually into a 48-well plate with 200 μL of a dye solution, prepared from a mixture of 3 μL of SYTO® (3.34 mM) and 3 μL of propidium iodide (20 mM) in 2 mL of PBS. The procedure was conducted at room temperature in the absence of light for 15 minutes. Eventually, the stained bacterial cells attached to the surfaces were examined under a Zeiss LSM 5 DUO laser scanning confocal microscope (Germany), and the images were obtained using an oil immersed 40× object lens at room temperature.

Analysis of Bacteria Attachment and Biofilm Formation by Field-Emission Scanning Electron Microscopy (FE-SEM):

FE-SEM was employed to evaluate the attachment and biofilm formation of S. aureus or E. coli on the uncoated and coated PDMS surfaces. Bacteria solution (3×10⁵ CFU·mL⁻¹, 20 μL) was seeded onto the uncoated and polymer-coated PDMS surfaces, followed by incubation at 37° C. for 1, 7 or 14 days. An additional 20 μL of MHB was added after every 24 hours to prevent the bacteria culture medium from drying out. At the predetermined time points, the PDMS surfaces were washed thrice with sterile PBS, followed by fixation with 2.5% glutaraldehyde in PBS overnight. The fixed bacteria were dehydrated with a series of graded ethanol solution (25%, 50%, 75%, 95%, and 100%, 10 min each) before the PDMS samples were mounted for platinum coating. Finally, a field emission scanning electron microscope (FE-SEM, JEOL JSM-7400F, Japan) was used to observe PDMS surfaces.

Analysis of Platelet Adhesion:

Fresh rat blood was centrifuged at 1000 rpm·min⁻¹ and at room temperature for 10 minutes to obtain platelet rich plasma (PRP) in the supernatant. Uncoated and polymer-coated PDMS surfaces were immersed in PRP and incubated at 37° C. for 30 minutes. The samples were then washed thrice with PBS, followed by the same bacteria fixation and FE-SEM analysis procedures described above.

Fluorescence Analysis for Protein Fouling:

Individual surfaces were incubated overnight with 20 μL of FITC-BSA solution (1 mg/mL) at 37° C. The surfaces were then washed thrice with clean sterile PBS solution before they were observed under an inverted fluorescence microscope (Olympus IX71, U.S.A). Meanwhile, the FITC-BSA solutions were removed from the respective surfaces, dissolved in 1 mL of sterile PBS solution. The fluorescence intensity of the solution was investigated using a Perkin-Elmer-LS55 luminescence spectrometer with Jobin Yvon Fluorolog-3 at 495 and 525 nm excitation and emission wavelengths respectively.

Hemolysis Test:

Freshly obtained rat blood was diluted to 4% (by volume) with PBS buffer. The red blood cell suspension in PBS (500 μL) was added into a 2 mL eppendorf tube, which contained uncoated or polymer-coated PDMS samples individually. The tube was incubated for 1 h at 37° C. for hemolysis to proceed. After incubation, the tube was centrifuged at 2200 rpm for 5 min at room temperature. Aliquots (100 mL) of the supernatant from each tube were transferred to a 96-well plate, and hemoglobin release was measured at 576 nm using the microplate reader (TECAN, Sweden). In this procedure, the red blood cells in PBS were used as a negative control, while the red blood cells lysed with 0.2% Triton-X were used as a positive control. The absorbance analysis for red blood cells lysed with 0.2% Triton X was taken as 100% hemolysis. The calculation for percentage of hemolysis was as follow: Hemolysis (%)=[(OD576 nm of the sample−OD576 nm of the negative control)/(OD576 nm of the positive control−OD576 nm of the negative control)]×100. The data was analyzed and expressed as mean and standard deviation of three replicates for quantification of each type of PDMS surface.

### Example 1: Synthesis of Monomers MTC-OCH₂BnCl and MTC-FPM

The detailed procedure for the synthesis of the monomers MTC-OCH₂BnCl and MTC-FPM are shown below Examples 1a and 1b. In general, the polymers were synthesized via metal-free organocatalytic ring-opening polymerization of MTC-OCH₂BnCl and MTC-FPM using MPEG as the macroinitiator in the presence of the co-catalysts DBU and TU. The reaction was quenched with trifluoroacetic acid and left to stir for 5 minutes. Subsequently, the quenched polymer was dissolved in a minimal amount of dichloromethane, and precipitated twice in cold diethyl ether before lyophilization. The dried polymer was first deprotected to expose the maleimide pendant groups, and completely quaternized with N,N-dimethylbutylamine to achieve a cationic polycarbonate polymer for surface attachment. Detailed procedures for the synthesis of 2.4 k-V and 2.4 k-S are given below.

### Example 1a: Synthesis of MTC-OCH₂BnCl Monomer

Briefly, in a dry two-neck 500 mL round bottom flask equipped with a stir bar, MTC-OH (3.08 g, 19.3 mmol) was first dissolved in dry THF (50 mL) with 5-8 drops of dimethylformamide (DMF). Subsequently, oxalyl chloride (3.3 mL) was added in one shot (pure form), followed by an additional 20 mL of THF. The solution was stirred for 90 minutes, after which volatiles were blow dried under a strong flow of nitrogen to yield a pale yellow solid intermediate (5-chlorocarboxy-5-methyl-1,3-dioxan-2-one, MTC-Cl). The solid then subjected to heat at 60° C. for 2-3 minutes for the removal of residual solvent, and was re-dissolved in dry CH₂Cl₂ (50 mL), followed by immersing the flask in an ice bath at 0° C. A mixture of para-chloromethylbenzyl alcohol (2.79 g, 17.8 mmol) and pyridine (1.55 mL, 19.3 mmol) were dissolved in dry CH₂Cl₂ (50 mL), which was added dropwise to the flask over a duration of 30 minutes, and allowed to stir at room temperature immediately after complete addition for an additional 2.5 hours (and not more than 3 hours). The reacted mixture was quenched by addition of 50 mL of brine, and the organic solvent was collected after separation. After removal of solvent, the crude product was purified by silica-gel flash column chromatography via a hexane-ethyl acetate solvent system (gradient elution up to 80% vol. ethyl acetate) to yield MTC-OCH2BnCl as a white solid. The crude product was further purified by recrystallization. The solid was dissolved in 1 mL of dichloromethane and ethyl acetate respectively, followed by addition of 50 mL of diethyl ether. The crystals were allowed to form at 0° C. for 2 days, and were subsequently obtained by washing the crystals with cold diethyl ether.

1H NMR (400 MHz, CDCl3, 22° C.): δ 7.37 (dd, J=20.2, 8 Hz, 4H, Ph-H), 5.21 (s, 2H, —OCH₂), 4.69 (d, J=13.6 Hz, 2H, —OCH₂C—), 4.59 (s, 2H, —CH₂Cl), 4.22 (d, J=14.8 Hz, 2H, —OCH₂C—), 1.32 (s, 3H, —C₂CH₃).

### Example 1b: Synthesis of MTC-FPM Monomer

Briefly, in a dry two-neck 500 mL round bottom flask equipped with a stir bar, MTC-OH (3.08 g, 19.3 mmol) was first dissolved in dry THF (50 mL) with 5-8 drops of dimethylformamide (DMF). Subsequently, oxalyl chloride (3.3 mL) was added in one shot (pure form), followed by an additional 20 mL of THF. The solution was stirred for 90 min, after which volatiles were blow dried under a strong flow of nitrogen to yield a pale yellow solid intermediate (5-chlorocarboxy-5-methyl-1,3-dioxan-2-one, MTC-Cl). The solid was then subjected to heat at 60° C. for 2-3 minutes for the removal of residual solvent, and re-dissolved in dry CH₂Cl₂ (50 mL), followed by immersing the flask in an ice bath at 0° C. A mixture of exo-3a,4,7,7a-Tetrahydro-2-(3-hydroxypropyl)-4,7-epoxy-1H-isoindole-1,3(2H)-dione (3.97 g, 17.8 mmol) and triethylamine (1.77 mL, 19.3 mmol) were dissolved in dry CH₂Cl₂ (50 mL), which was added dropwise to the flask over a duration of 30 minutes, and allowed to stir at room temperature immediately after complete addition for an additional 24 hours. The reacted mixture was quenched by addition of 50 mL of water, and the organic solvent was collected after separation. After removal of solvent, the crude product was dissolved in 4 mL of CH₂Cl₂, followed by addition of 50 mL of diethyl ether for recrystallization. The crystals were allowed to form at room temperature, and were subsequently obtained by washing with cold diethyl ether.

1H NMR (400 MHz, CDCl₃, 22° C.): δ 6.51 (s, 2H, —CH═CH), 5.25 (s, 2H, —OCHC₂—), 4.74 (d, 2H, J=14.4 Hz, —OCH₂CC₂—), 4.22 (d, 2H, J=14.8 Hz, —OCH₂CC₂—), 4.11 (t, 2H, J=6.0 Hz, —OCH₂CH₂—), 3.58 (t, 2H, J=6.6 Hz, CH₂CH₂NC—), 2.85 (s, 2H, —COCHC—), 1.96 (quin, 6.4 Hz, 2H, —CONCCOCHC—), 1.38 (s, 3H, —C₂CH₃).

### Example 2: General Synthesis of Disclosed Polymers

In general, a macroinitiator was used to ring-open cyclic carbonate monomers. The product was then deprotected to expose anchoring groups. The deprotected product may be followed by subsequent quaternization to yield the disclosed copolymers (Scheme 1 or Scheme 2).

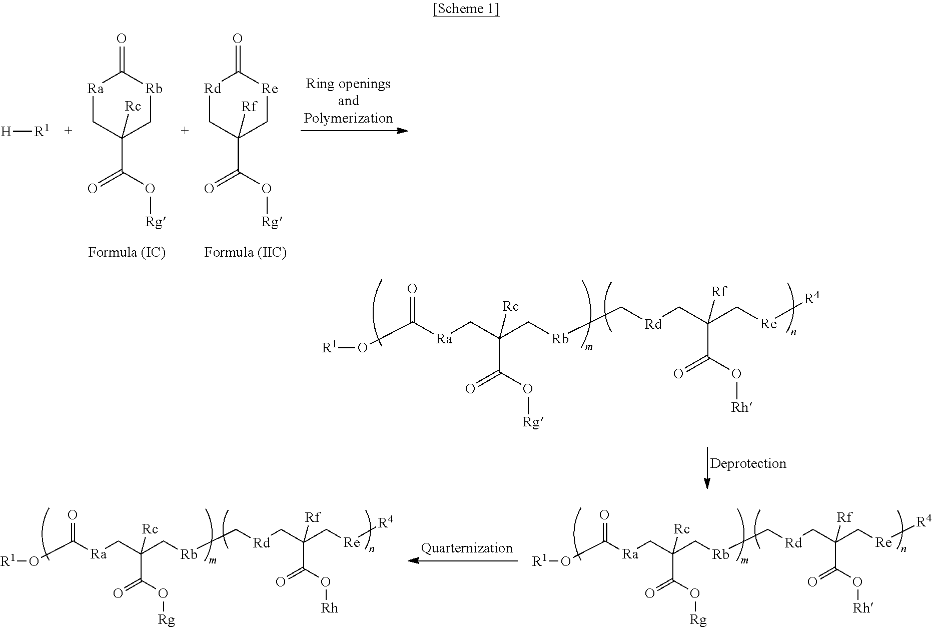

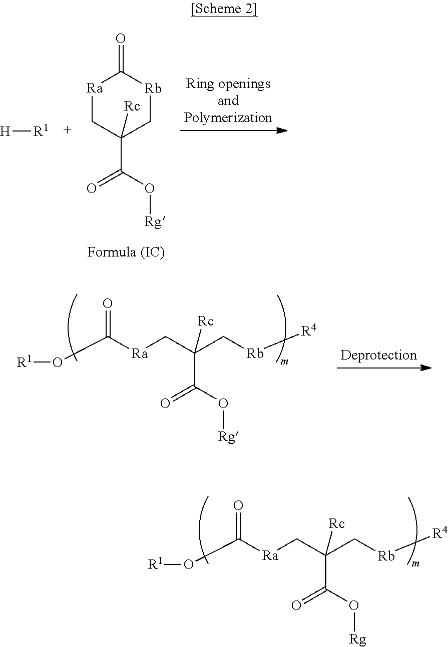

wherein R¹, R⁴, Ra, Rb, Rc, Rd, Re, Rf, Rg, Rh, Rg′, Rh′, m and n are defined above.

### Example 2a: 2.4 k-V and 2.4 k-S

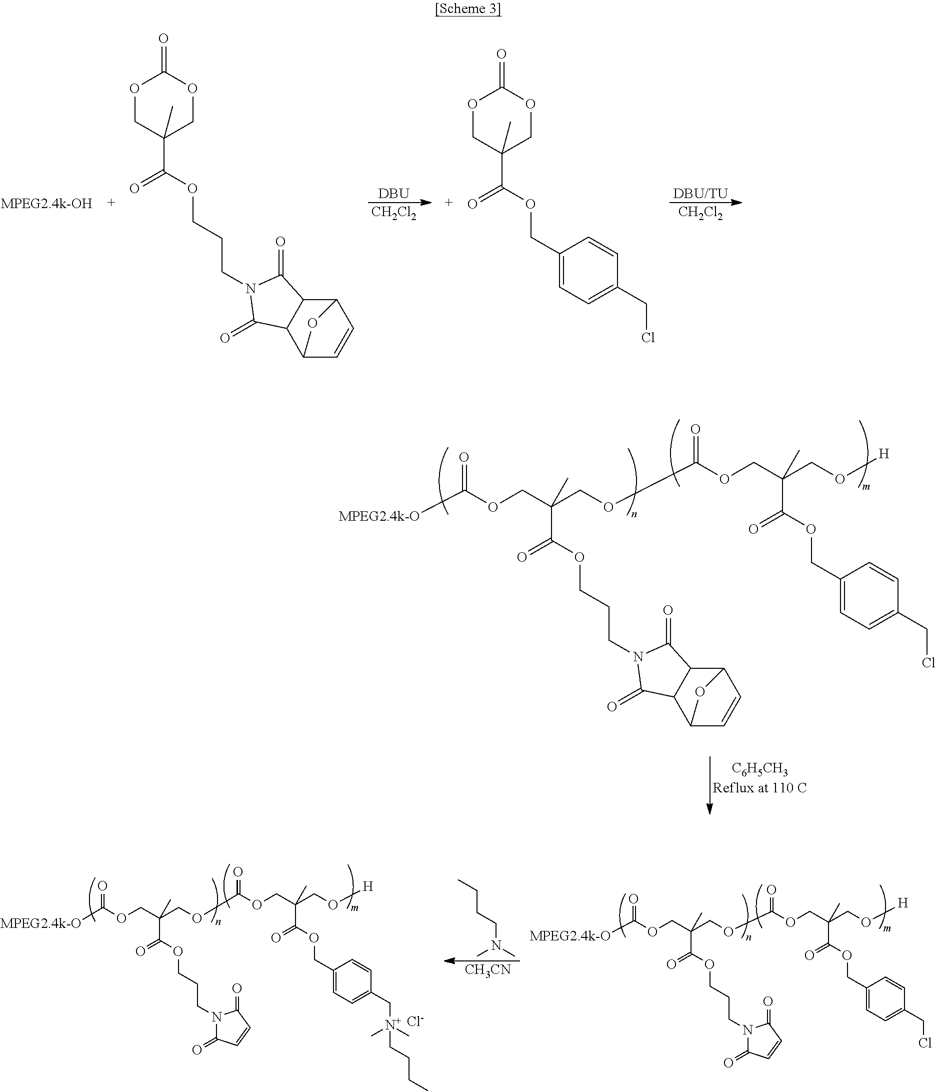

TABLE 1
Compositions of tri-block copolymers consisting of PEG and polycarbonates

| | Feed molar ratio | | | |
|---|---|---|---|---|
| | (PEG:MTC-FPM:MTC- | | | |
| | OCH₂BnCl) with | | | Composition after |
| Polymer | TU/DBU 5% mol | Composition^{a} | Mw^{a} (PDI) | Quaternization^{a} |
| 2.4k-V | 1:10:140 | PEG-(MTC-FPM)₇- | 34829 (1.20) | PEG-P(MC)₅-CP(C)₉₀ |
| | | (MTC-OCH₂BnCl)₁₀₀ | | |
| 2.4k-S | 1:10:140 | PEG-(MTC-FPM)₃- | 27394 (1.28) | PEG-P(MC)₃-CP(C)₈₀ |
| | | (MTC-OCH₂BnCl)₈₀ | | |

^{a}Determined from ¹H NMR Spectrum

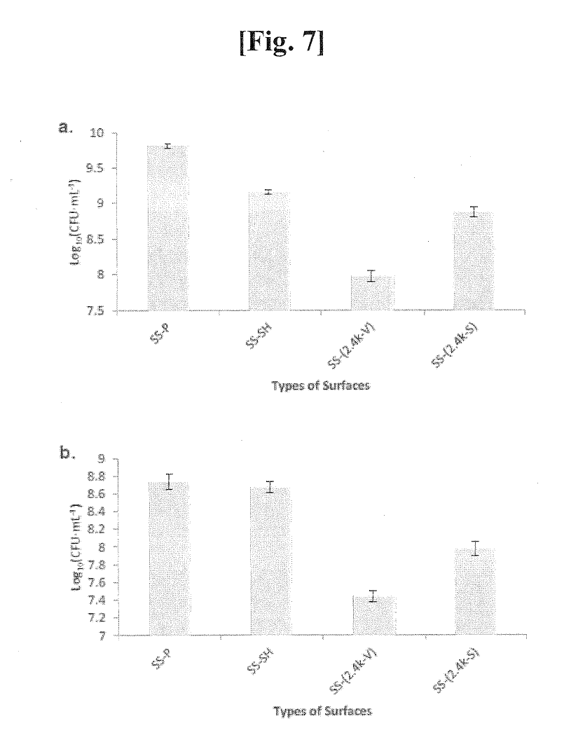

Monomethylether PEG (MPEG) with 2.4 kDa was used as a macroinitiator to ring-open the cyclic carbonate monomers MTC-Furan protected maleimide (MTC-FPM) and MTC-benzyl chloride (MTC-OCH₂BnCl) in a sequential order, followed by deprotection to expose the maleimide anchoring groups, and subsequent complete quaternization with dimethyl butyl amine to yield triblock copolymers of PEG, maleimide-functionalized polycarbonate (PMC) and cationic polycarbonate (CPC), i.e. PEG-PMC-CPC and PEG-CPC-PMC (Scheme 4, Table 1). Each of the polymers had PEG of the same molecular weight for providing antifouling function, cationic polycarbonates of comparable length for antibacterial property and maleimide-functionalized polycarbonate for surface attachment via Michael addition reaction. ¹H NMR integration values of monomers against the PEG initiator were correlated, hence confirming controlled polymerization via initial monomer to initiator feed ratio. In addition, the proton NMR analysis displayed all the peaks associated with both initiator and monomers. Both polymers had narrow molecular weight distribution with polydispersity index (PDI) ranging between 1.20 to 1.28. Subsequently, after precipitating twice in cold diethyl ether, the two polymers were isolated and dried. The polymers were subsequently dissolved in toluene and heated to 110° C. overnight for the deprotection of pendant furan-protected maleimide. The deprotected polymers were reprecipitated in cold diethyl ether twice, and ¹H NMR showed a downfield shift from 6.49 to 6.68 ppm, which was correlated to the deprotected maleimide pendant groups. Excess quantity of N,N-dimethylbutylamine was then added to the polymers dissolved in 20 mL of acetonitrile to achieve complete quaternization. The fully quaternized polymers were purified via dialysis in acetonitrile/isopropanol (1:1 in volume) for 2 days. From 1H NMR analysis, the presence of a new distinct peak at 2.99 ppm confirmed that quaternization of —OCH₂BnCl pendant groups took place (FIGS. 7a to 7c).

### Example 2b: 2.4 k-M, 2.4 k-MC, 10 k-M, and 10 k-MC

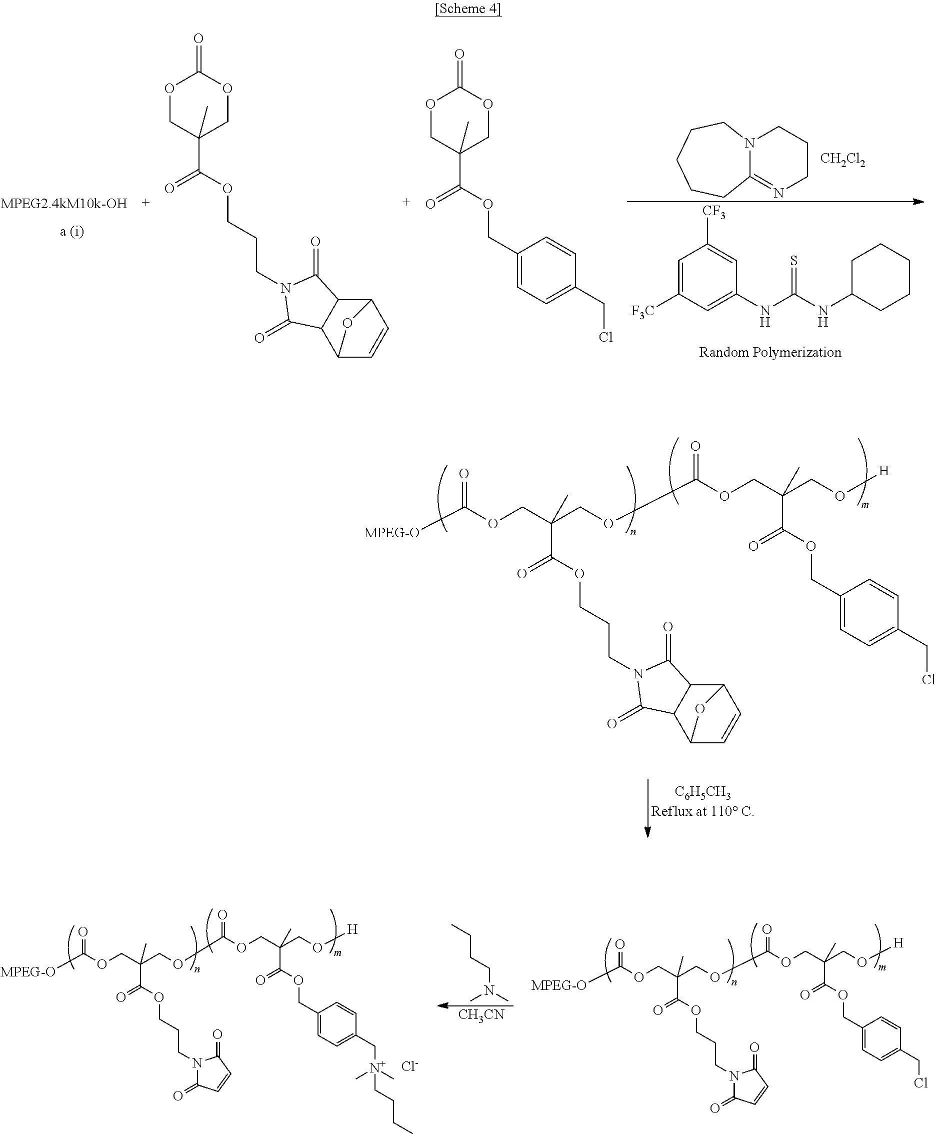

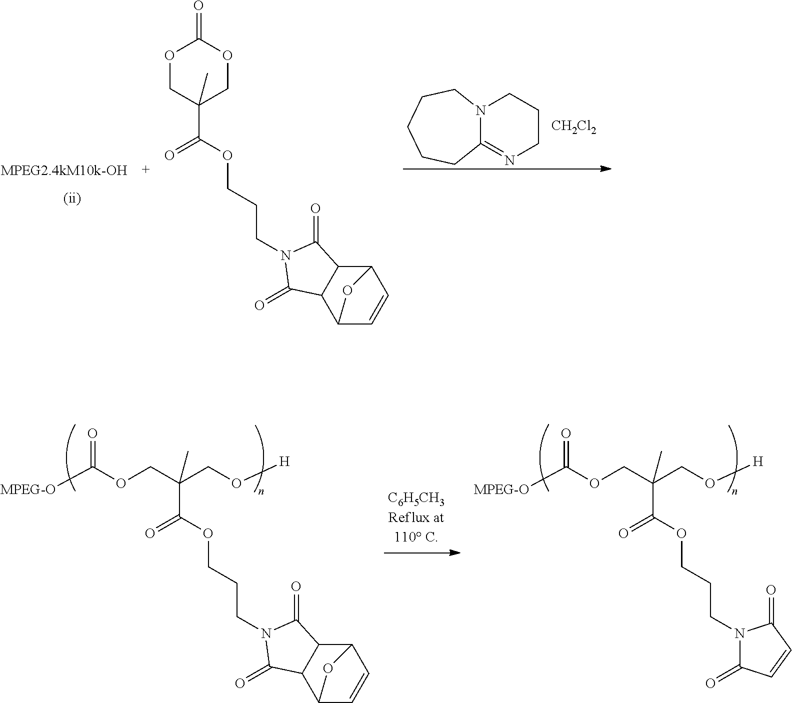

TABLE 2
Compositions of di-block copolymers consisting of PEG and polycarbonates

| | Feed molar ratio | | | |
|---|---|---|---|---|
| | (Initiator:MTC-FPM:MTC- | | | |
| | OCH₂BnCl) with | | | Composition after |
| Polymer | TU/DBU 5% mol | Composition^{a} | Mw^{a} (PDI) | Quaternization^{a} |
| 2.4k-MC | 1:10:140 | MPEG 2.4K-P(MTC-FPM)₈- | 28623 (1.28) | MPEG 2.4K-P(MC)₅-CP(C)₇₂ |
| | | P(MTC-OCH₂BnCl)₇₈ | | |
| 10k-MC | 1:10:140 | MPEG 10K-P(MTC-FPM)₉- | 37783 (1.16) | MPEG 10K-P(MC)₆-CP(C)₇₂ |
| | | P(MTC-OCH₂BnCl)₈₂ | | |
| 2.4k-M | 1:10:0 | MPEG 2.4K-P(MTC-FPM)₈ | 5251 (1.08) | MPEG 2.4K-P(MC)₆ |
| 10k-M | 1:10:0 | MPEG 10K-P(MTC-FPM)₄ | 11425 (1.10) | MPEG 10K-P(MC)₃ |

^{a}Determined from ¹H NMR Spectrum

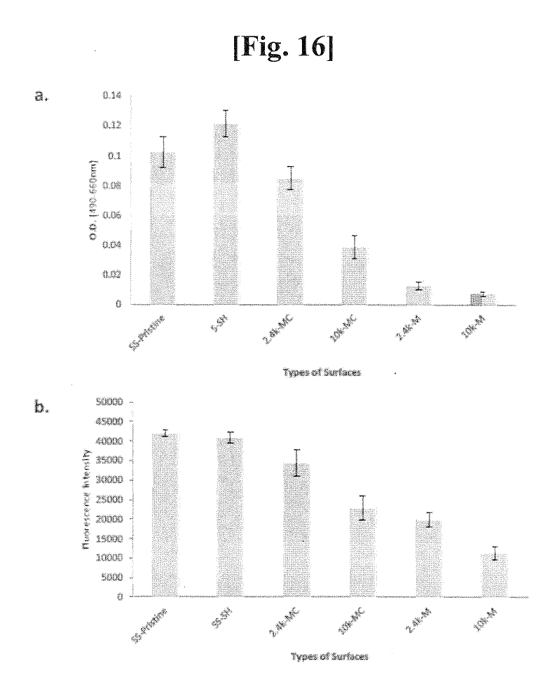

Diblock copolymers (2.4 k-M and 10 k-M) of PEG and maleimide-functionalized polycarbonate (PMC) were prepared via organocatalytic ring-opening polymerization (ROP). In order to study the antifouling effect of PEG, MPEGs of different lengths (2.4 kDa and 10 kDa) were utilized as macroinitiators as shown in Scheme 3. In addition, two diblock copolymers (2.4 k-MC and 10 k-MC) consisting of MPEG (2.4 kDa or 10 kDa) and cationic polycarbonate with maleimide functional groups randomly copolymerized (CP(M-C)) were as a comparison. For 2.4 k-M and 10 k-M polymers, there are 6 and 3 maleimide groups respectively (Table 2). In 2.4 k-MC and 10 k-MC polymers, there are 72 cationic repeat units and 5-6 maleimide groups (Table 2). ¹H NMR integration values of monomers against the MPEG initiator are well correlated, hence confirming controlled polymerization via strict initial monomer to initiator feed ratio. In addition, the proton NMR analysis displayed all the peaks associated with both initiator and monomers. All polymers had narrow molecular weight distribution with polydispersity index (PDI) ranging between 1.09 to 1.28. Subsequently, after precipitating twice in cold diethyl ether, the four polymers were isolated and dried. The polymers were subsequently dissolved in toluene and heated to 110° C. overnight in order to deprotect pendant furan-protected maleimide. The deprotected polymers were re-precipitated into cold diethyl ether twice, and ¹H NMR showed a downfield shift from 6.49 to 6.68 ppm, correlating to the deprotected maleimide pendant groups. Excess quantity of N,N-dimethylbutylamine was then added to the two polymers containing OCH₂BnCl pendant groups, which were dissolved in 20 mL of acetonitrile to achieve complete quaternization. The fully quaternized polymers were further purified via dialysis in acetonitrile/isopropanol (1:1, volume by volume) for 2 days. From ¹H NMR analysis, the presence of a new distinct peak at 2.99 ppm demonstrated that quaternization of OCH₂BnCl pendant groups took place (FIGS. 16a to 16c).

### Example 3: Polymer Synthesis of Polymer 2.4 k-V

Details of the metal-free organocatalytic ring opening polymerization for polymer 2.4 k-V are given as an example. In a glove-box, 24.1 mg (0.010 mmol) of 2.4 kDa MPEG-OH initiator and 36.7 mg (0.10 mmol) of MTC-FPM were charged in a 20 mL glass vial equipped with a stir bar. Dichloromethane was added and the concentration was adjusted to 2 M with respect to the monomer. Once the initiator and monomers were completely dissolved, 1.5 μL (0.01 mmol) of DBU was added to initiate the polymerization. After 45 minutes, the last block was adjoined to the polymer by adding 0.3 g (1.0 mmol) of MTC-OCH₂BnCl. Additional catalysts, 6 μL (0.040 mmol) of DBU and 18.6 mg (0.050 mmol) of TU, were added to the pot and left to stir at room temperature for another 40 minutes before quenching with 30 μL of trifluoroacetic acid. Subsequently, the polymer intermediate was purified immediately via precipitation twice in cold diethyl ether, and was dried on a vacuum line until a constant weight was achieved.

1H NMR (400 MHz, CDCl₃, 22° C.) δ 7.38-7.27 (m, 400H, —C₆H4CH₂Cl), 6.51-6.42 (m, 14H, —CHOC₂H₄CHO—), 5.27-5.21 (m, 14H, —R₂CHOCHR₂—), 5.15-5.12 (m, 200H, —COOCH₂—), 4.64-4.49 (m, 200H, —C₆H₄CH₂Cl), 4.46-4.39 (m, 14H, —COOCH₂CH₂—), 4.37-3.96 (m, 426H, —CH₂OCOO—), 3.87-3.60 (m, 217H, —OCH₂CH₂— from 2.4 kDa MPEG), 3.56-3.51 (m, 14H, —CH₂CH₂NR₂), 2.91-2.81 (m, 14H, —CC₂HCC₂H—), 2.17-1.98 (m, 14H, —OCH₂CH₂CH₂—), 1.26-1.19 (m, 321H, —CH₃).

The protected polymer was then deprotected by dissolving in 10 mL of toluene and heated to 110° C. overnight. After that, the toluene was removed under vacuum and the deprotected polymer was dissolved in 2 mL of dichloromethane and precipitated in cold diethyl ether. The polymer was subsequently dried on a vacuum line until a constant weight was achieved.

1H NMR (400 MHz, CDCl3, 22° C.) 7.40-7.24 (m, 396H, —C6H₄CH₂Cl), 6.72-6.65 (m, 12H, —COC₂H₄CO—), 5.21-5.02 (m, 198H, —COOCH₂—), 4.59-4.48 (m, 198H, —C₆H₄CH₂Cl), 4.45-4.40 (m, 12H, —COOCH₂CH₂—), 4.38-3.94 (m, 420H, —CH₂OCOO—), 3.83-3.60 (m, 217H, —OCH₂CH₂— from 2.4 kDa MPEG), 3.59-3.54 (m, 12H, —CH₂CH₂NR₂), 2.17-1.98 (m, 12H, —OCH₂CH₂CH₂—), 1.27-1.14 (m, 315H, —CH₃).

Finally the polymer was dissolved in 20 mL of acetonitrile, and an excess (2 mL) of N,N-dimethylbutylamine was added to fully quaternize the OBnCl pendant groups. The reaction mixture was stirred overnight in a 50 mL round bottom flask at room temperature, and the solvent was then removed in vacuo. The obtained product was dissolved in a mixture of acetonitrile and isopropanol (1:1 in volume), and dialysis in acetonitrile/isopropanol (1:1, volume by volume) for 2 days. Finally, the solvent was removed under reduced pressure, and the final product was dried in a vacuum oven until a constant mass was achieved.

Polymer 2.4 k-V:

1H NMR (400 MHz, (CD₃)2CO, 22° C.) 7.65-7.34 (m, 360H, —C₆H₄CH₂Cl), 7.18-6.22 (m, 10H, —COC₂H₄CO—), 5.46-5.29 (m, 10H, —COOCH₂CH₂—), 5.25-5.04 (m, 180H, —COOCH₂—), 4.80-4.52 (m, 180H, —C₆H₄CH₂Cl 4.40-3.90 (m, 380H, —CH₂OCOO—), 3.70-3.56 (m, 10H, —CH₂CH₂NR₂), 3.54-3.38 (m, 217H, —OCH₂CH₂— from 2.4 kDa MPEG), 3.34-3.20 (m, 180H, —N⁺ CH₂CH₂CH₂—), 2.99 (s, 540H, —N⁺[CH₃]2), 2.29-2.10 (m, 10H, —OCH₂CH₂CH₂—), 1.81-1.70 (m, 180H, —N⁺ CH₂CH₂CH₂—), 1.34-1.25 (m, 180H, —N⁺ CH₂CH₂CH₂—), 1.23-1.10 (m, 270H, —N⁺ CH₂CH₂CH₂CH₃), 1.05-0.84 (m, 285H, —CH₃).

### Example 4: Polymer Synthesis of Polymer 2.4 k-S

Polymer 2.4 k-S was synthesized in similar fashion, with slight modification to the sequence of monomer addition to the reaction pot. In a glove-box, 24.1 mg (0.010 mmol) of 2.4 kDa MPEGOH initiator and 0.3 g (1.0 mmol) of MTC-OCH₂BnCl were charged in a 20 mL glass vial equipped with a stir bar for the first and second block polymer synthesis. Dichloromethane was added and the concentration was adjusted to 2 M with respect to the monomer. Once the initiator and monomers were completely dissolved, 7.5 μL (0.05 mmol) of DBU and 18.6 mg (0.050 mmol) of TU were added to initiate the polymerization. After 15 minutes, the last block of the polymer was completed by adding 36.7 mg (0.10 mmol) of MTC-FPM. The reaction pot was left to stir at room temperature for another 40 min before quenching with 30 μL of trifluoroacetic acid. Subsequently, the polymer intermediate was purified immediately via precipitation twice in cold diethyl ether, and was dried on a vacuum line until a constant weight was achieved.

Polymer 2.4 k-S (Protected Maleimide):

1H NMR (400 MHz, CDCl₃, 22° C.) 7.39-7.25 (m, 320H, —C₆H₄CH₂Cl), 6.59-6.40 (m, 6H, —CHOC₂H₄CHO—), 5.26-5.21 (m, 6H, —R₂CHOCHR₂—), 5.18-5.02 (m, 160H, —COOCH₂—), 4.81-4.63 (m, 160H, —C₆H₄CH₂Cl), 4.62-4.48 (m, 6H, —COOCH₂CH₂—), 4.49-3.99 (m, 332H, —CH₂OCOO—), 3.85-3.61 (m, 217H, —OCH₂CH₂— from 2.4 kDa MPEG), 3.59-3.53 (m, 6H, —CH₂CH₂NR₂), 2.91-2.75 (m, 6H, —CC₂HCC₂H—), 1.92-1.87 (m, 6H, —OCH₂CH₂CH₂—), 1.27-1.20 (m, 249H, —CH₃).

Polymer 2.4 k-S (Deprotected Maleimide):

1H NMR (400 MHz, CDCl₃, 22° C.) 7.41-7.24 (m, 320H, —C₆H₄CH₂Cl), 6.73-6.63 (m, 6H, —CHOC₂H₄CHO—), 5.25-5.03 (m, 160H, —COOCH₂—), 4.65-4.46 (m, 160H, —C₆H₄CH₂Cl), 4.44-4.40 (m, 6H, —COOCH₂CH₂—), 4.38-3.97 (m, 332H, —CH₂OCOO—), 3.84-3.61 (m, 217H, —OCH₂CH₂— from 2.4 kDa MPEG), 3.57-3.52 (m, 6H, —CH₂CH₂NR₂), 1.91-1.88 (m, 6H, —CH₂CH₂CH₂—), 1.34-1.14 (m, 249H, —CH₃).

Polymer 2.4 k-S:

1H NMR (400 MHz, (CD₃)2CO, 22° C.) 7.69-7.25 (m, 320H, —C₆H₄CH₂Cl), 7.17-6.55 (m, 6H, —COC₂H₄CO—), 5.42-5.27 (m, 6H, —COOCH₂CH₂—), 5.26-4.92 (m, 160H, —COOCH₂—), 4.89-4.47 (m, 160H, —C₆H₄CH₂Cl), 4.45-3.81 (m, 332H, —CH₂OCOO—), 3.61-3.54 (m, 6H, —CH₂CH₂NR₂), 3.54-3.40 (m, 217H, —OCH₂CH₂— from 2.4 kDa MPEG), 3.35-3.24 (m, 160H, —N⁺ CH₂CH₂CH₂—), 2.98 (s, 480H, —N⁺[CH₃]₂), 2.23-2.00 (m, 6H, —OCH₂CH₂CH₂—), 1.87-1.61 (m, 160H, —N⁺ CH₂CH₂CH₂—), 1.36-1.07 (m, 405H, —N⁺ CH₂CH₂CH₂— & —N⁺ CH₂CH₂CH₂CH₃), 1.05-0.83 (m, 249H, —CH₃).

### Example 5: Polymer Synthesis of Polymer 2.4 k-MC

Details of the metal-free organocatalytic ring opening polymerization for polymer 2.4 k-MC are given below as an example.

In a glove-box, 17.2 mg (0.0072 mmol) of 2.4 kDa MPEG-OH initiator, 0.3 g (0.001 mol) of MTC-CH₂OBnCl and 26.2 mg (0.072 mmol) of MTC-FPM were charged in a 20 mL glass vial equipped with a stir bar. Dichloromethane was added and the concentration was adjusted to 2 M with respect to the monomer. Once the initiator and monomers were completely dissolved, 6.3 μL of DBU and 18.6 mg of TU (0.05 mmol) were added to initiate the polymerization. After 20 minutes, the reaction was quenched with 30 μL of trifluoroacetic acid. Subsequently, the polymer intermediate was purified immediately via precipitation twice in cold diethyl ether, and was dried on a vacuum line until a constant weight was achieved.

1H NMR (400 MHz, CDCl₃, 22° C.): δ 7.42-7.26 (m, 312H, —C₆H₄CH₂Cl), 6.51-6.46 (m, 16H, —CHOC₂H₄CHO—), 5.27-5.19 (m, 16H, —R₂CHOCHR₂—), 5.17-5.06 (m, 156H, —COOCH₂—), 4.62-4.49 (m, 156H, —C₆H₄CH₂Cl), 4.47-4.39 (m, 16H, —COOCH₂CH₂—), 4.35-3.99 (m, 312H, —CH₂OCOO—), 3.90-3.61 (m, 217H, —OCH₂CH₂— from 2.4 kDa MPEG), 3.57-3.49 (m, 16H, —CH₂CH₂NR₂), 2.88-2.78 (m, 16H, —CC₂HCC₂H—), 1.82-1.72 (m, 16H, —OCH₂CH₂CH₂—), 1.32-1.13 (m, 234H, —CH₃).

The furan-protected maleimide polymer was then deprotected by dissolving the polymer in 10 mL of toluene and heated to 110° C. overnight. After that, the toluene was removed under vacuum and the deprotected polymer was dissolved in 2 mL of dichloromethane and precipitated in cold diethyl ether. The polymer was subsequently dried on a vacuum line until a constant weight was achieved.

1H NMR (400 MHz, CDCl₃, 22° C.) δ 7.40-7.23 (m, 308H, —C₆H₄CH₂Cl), 6.72-6.61 (m, 12H, —COC₂H₄CO—), 5.18-5.05 (m, 154H, —COOCH₂—), 4.60-4.49 (m, 154H, —C₆H₄CH₂Cl), 4.47-4.35 (m, 12H, —COOCH₂CH₂—), 4.34-4.00 (m, 308H, —CH₂OCOO—), 3.88-3.60 (m, 217H, —OCH₂CH₂— from 2.4 kDa MPEG), 3.59-3.53 (m, 12H, —CH₂CH₂NR₂), 1.96-1.87 (m, 12H, —OCH₂CH₂CH₂—), 1.33-1.14 (m, 231H, —CH₃).

Finally the polymer was dissolved in 20 mL of acetonitrile, and an excess (2 mL) of N,N-dimethyl-butylamine was added to fully quaternize the OBnCl pendant groups. The reaction mixture was stirred overnight in a 50 mL round bottom flask at room temperature, and the solvent was then removed in vacuo. The resulting crude product was dissolved in a mixture of acetonitrile and isopropanol (1:1 in volume), and dialysed in acetonitrile/isopropanol (1:1, volume by volume) for 2 days. Finally, the solvent was removed under reduced pressure, and the final product was dried in a vacuum oven until a constant mass was achieved.

1H NMR (400 MHz, (CD₃)2CO, 22° C.) 7.90-7.26 (m, 288H, —C₆H₄CH₂Cl), 7.22-6.05 (m, 6H, —COC₂H₄CO—), 5.52-5.30 (m, 6H, —COOCH₂CH₂—), 5.29-4.90 (m, 144H, —COOCH₂—), 4.81-4.52 (m, 144H, —C₆H₄CH₂Cl), 4.46-3.89 (m, 288H, —CH₂OCOO—), 3.84-3.44 (m, 6H, —CH₂CH₂NR₂), 3.43-3.41 (m, 217H, —OCH₂CH₂-from 2.4 kDa MPEG), 3.33-3.21 (m, 144H, —N+CH₂CH₂CH₂—), 2.99 (s, 432H, —N⁺[CH₃]2), 2.26-2.12 (m, 6H, —OCH₂CH₂CH₂—), 1.89-1.68 (m, 144H, —N⁺CH₂CH₂CH₂—), 1.43-0.99 (m, 360H, —N+CH₂CH₂CH₂— and —N+CH₂CH₂CH₂CH₃), 0.98-0.71 (m, 216H, —CH₃).

### Example 6: Polymer Synthesis of Polymer 10 k-MC

Polymer 10 k-MC was synthesized in similar fashion to polymer 2.4 k-MC, with slight modification to the amount of macroinitiator used. In a glove-box, 71.7 mg (0.0072 mmol) of Mn 10 kDa MPEG-OH initiator, 0.3 g (0.001 mol) of MTC-CH₂OBnCl and 26.2 mg (0.072 mmol) of MTC-FPM were charged in a 20 mL glass vial equipped with a stir bar. Dichloromethane was added and the concentration was adjusted to 2 M with respect to the monomer. Once the initiator and monomers were completely dissolved, 6.3 μL of DBU and 18.6 mg of TU (0.05 mmol) were added to initiate the polymerization. After 20 minutes, the reaction was quenched with 30 μL of trifluoroacetic acid. Subsequently, the polymer intermediate was purified immediately via precipitation twice in cold diethyl ether, and was dried on a vacuum line until a constant weight was achieved. Deprotection and purification protocols for 10 k-MC are similar to that of 2.4 k-MC described above.

Polymer 10 k-FPMC (Protected Maleimide):

1H NMR (400 MHz, CDCl3, 22° C.) δ 7.43-7.25 (m, 328H, —C6H4CH2Cl), 6.52-6.41 (m, 14H, —CHOC2H4CHO—), 5.28-5.19 (m, 14H, —R2CHOCHR2-), 5.18-5.06 (m, 164H, —COOCH2-), 4.61-4.51 (m, 164H, —C6H4CH2Cl), 4.48-4.34 (m, 14H, —COOCH2CH2-), 4.33-3.99 (m, 328H, —CH2OCOO—), 3.90-3.61 (m, 908H, —OCH2CH2- from 10 kDa MPEG), 3.59-3.50 (m, 14H, —CH2CH2NR2), 2.88-2.78 (m, 14H, —CC2HCC2H—), 1.81-1.75 (m, 14H, —OCH2CH2CH2-), 1.30-1.15 (m, 246H, —CH3).

Polymer 10 k-MC (Deprotected Maleimide):

1H NMR (400 MHz, CDCl3, 22° C.) δ 7.41-7.25 (m, 312H, —C6H4CH2Cl), 6.77-6.56 (m, 12H, —COC2H4CO—), 5.18-5.06 (m, 156H, —COOCH2-), 4.61-4.50 (m, 156H, —C6H4CH2Cl), 4.45-4.35 (m, 12H, —COOCH2CH2-), 4.33-3.96 (m, 312H, —CH2OCOO—), 3.89-3.58 (m, 908H, —OCH2CH2- from 10 kDa MPEG), 3.57-3.53 (m, 12H, —CH2CH2NR2), 1.82-1.75 (m, 12H, —OCH2CH2CH2-), 1.33-1.11 (m, 234H, —CH3).

Polymer 10 k-MC (Quaternized):

1H NMR (400 MHz, (CD3)2CO, 22° C.) δ 7.75-7.38 (m, 288H, —C6H4CH2Cl), 7.21-6.50 (m, 12H, —COC2H4CO—), 5.31-5.05 (m, 144H, —COOCH2-), 4.80-4.53 (m, 144H, —C6H4CH2Cl), 4.39-4.37 (m, 12H, —COOCH2CH2-), 4.36-3.88 (m, 288H, —CH2OCOO—), 3.71-3.45 (m, 12H, —CH2CH2NR2), 3.43-3.39 (m, 908H, —OCH2CH2- from 10 kDa MPEG), 3.34-3.23 (m, 144H, —N∘+CH2CH2CH2-), 2.99 (s, 432H, —N∘+[CH3]2), 2.28-1.90 (m, 12H, —OCH2CH2CH2-), 1.85-1.63 (m, 144H, —N∘+CH2CH2CH2-), 1.38-1.00 (m, 360H, —N∘+CH2CH2CH2- & —N∘+CH2CH2CH2CH3), 0.99-0.70 (m, 216H, —CH3).

### Example 7: Polymer Synthesis of Polymer 2.4 k-M

Details of the metal-free organocatalytic ring opening polymerization for the polymer 2.4 k-M without cationic polycarbonate are given below as an example.

In a glove-box, 13.1 mg (0.055 mmol) of 2.4 kDa MPEG-OH initiator and 0.2 g (0.55 mmol) of MTC-FPM were charged in a 20 mL glass vial equipped with a stir bar. Dichloromethane was added and the concentration was adjusted to 2 M with respect to the monomer. Once the initiator and monomers were completely dissolved, 4.1 μL (0.027 mmol) of DBU was added to initiate the polymerization. After 24 hours, the reaction was quenched with excess benzoic acid. Subsequently, the polymer intermediate was purified immediately via precipitation twice in cold diethyl ether, and was dried on a vacuum line until a constant weight was achieved.

1H NMR (400 MHz, CDCl₃, 22° C.): δ 6.56-6.46 (m, 16H, —CHOC₂H₄CHO), 5.29-5.20 (m, 16H, —R₂CHOCHR₂—), 4.47-4.16 (m, 32H, —COOCH₂—), 4.11-4.00 (m, 16H, —COOCH₂CH₂—), 3.84-3.60 (m, 217H, —OCH₂CH₂— from 2.4 kDa MPEG), 3.59-3.52 (m, 16H, —CH₂CH₂NR₂), 2.93-2.80 (m, 16H, —CC₂HCC₂H—), 1.95-1.86 (m, 16H, —OCH₂CH₂CH₂—), 1.35-1.24 (m, 24H, —CH₃).

The furan-protected maleimide polymer was then deprotected by dissolving the polymer in 10 mL of toluene and heated to 110° C. overnight. After that, the toluene was removed under vacuum and the deprotected polymer was dissolved in 2 mL of dichloromethane and precipitated in cold diethyl ether. The polymer was subsequently dried on a vacuum line until a constant weight was achieved.

1H NMR (400 MHz, CDCl3, 22° C.) δ 6.76-6.69 (m, 12H, —COC₂H₄CO—), 4.47-4.18 (m, 24H, —COOCH₂—), 4.14-4.04 (m, 12H, —COOCH₂CH₂—), 3.91-3.62 (m, 217H, —OCH₂CH₂— from 2.4 kDa MPEG), 3.61-3.51 (m, 12H, —CH₂CH₂NR₂), 2.00-1.88 (m, 12H, —OCH₂CH₂CH₂—), 1.35-1.23 (m, 18H, —CH₃).

### Example 8: Polymer Synthesis of Polymer 10 k-M

Polymer 10 k-M was synthesized in similar fashion to polymer 2.4 k-M, with slight modification to the amount of macroinitiator used. In a glove-box, 0.55 mg (0.055 mmol) of 10 kDa MPEG-OH initiator and 0.2 g (0.55 mmol) of MTC-FPM were charged in a 20 mL glass vial equipped with a stir bar. Dichloromethane was added and the concentration was adjusted to 2 M with respect to the monomer. Once the initiator and monomers were completely dissolved, 4.1 μL (0.027 mmol) of DBU was added to initiate the polymerization. After 24 hours, the reaction was quenched with excess benzoic acid. Subsequently, the polymer intermediate was purified immediately via precipitation twice in cold diethyl ether, and was dried on a vacuum line until a constant weight was achieved. Deprotection and purification protocols for polymer 10 k-M are similar to those of polymer 2.4 k-M described above.

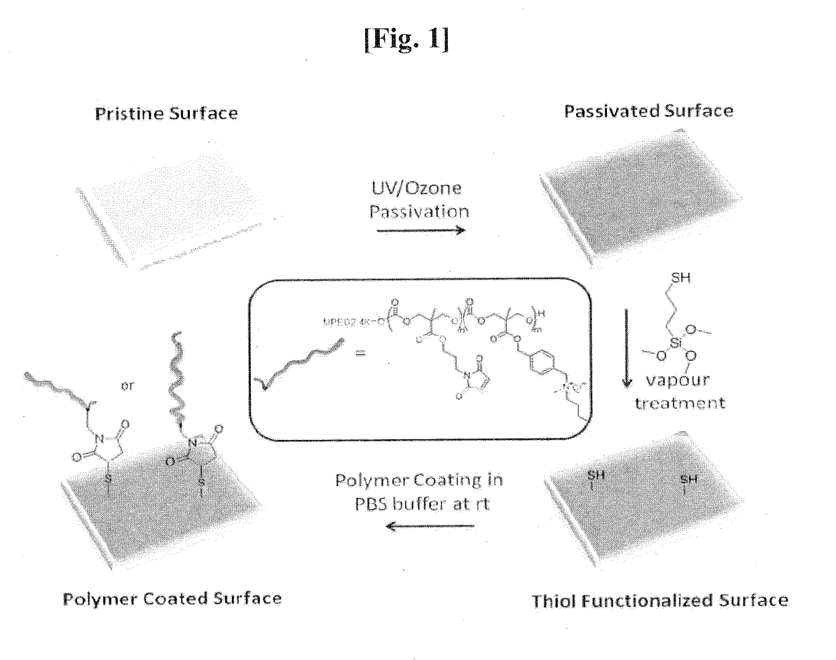

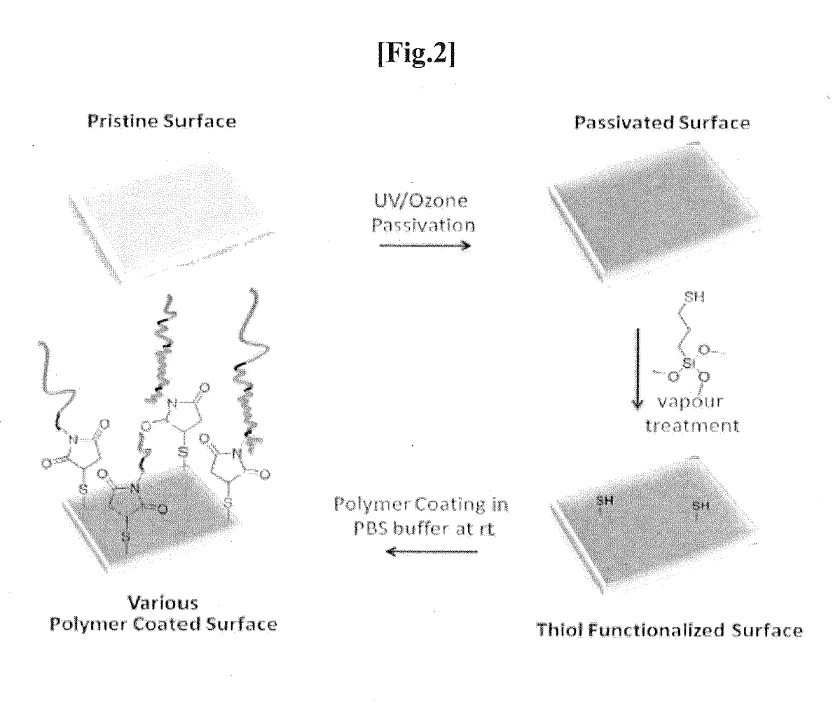

FIG. 1 shows the general process of a polymer coating process with triblock copolymers of PEG, cationic polycarbonate (CPC) and maleimide-functionalized polycarbonate (PMC). FIG. 2 shows the general process of a polymer coating process with diblock copolymers of PEG and cationic polycarbonate containing maleimide groups (i.e. 2.4 k-MC and 10 k-MC) and copolymers of PEG and maleimide-functionalized polycarbonate (i.e. 2.4 k-M and 10 k-M). PEG: on the top of the molecule; maleimide-functionalized polycarbonate block: anchoring point, close to the surface; cationic carbonate moiety: randomly copolymerized with maleimide-functionalized carbonate moiety.

Polymer 10 k-FPM (Protected Maleimide):

1H NMR (400 MHz, CDCl₃, 22° C.): δ 6.64-6.40 (m, 8H, —CHOC₂H₄CHO—), 5.33-5.16 (m, 8H, —R₂CHOCHR₂—), 4.39-4.22 (m, 16H, —COOCH₂—), 4.10-4.01 (m, 8H, —COOCH₂CH₂—), 3.85-3.58 (m, 908H, —OCH₂CH₂— from 10 kDa MPEG), 3.52-3.49 (m, 8H, —CH₂CH₂NR₂), 2.92-2.78 (m, 8H, —CC₂HCC₂H—), 2.00-1.84 (m, 8H, —OCH₂CH₂CH₂—), 1.37-1.18 (m, 12H, —CH₃).

Polymer 10 k-M (Deprotected Maleimide):

1H NMR (400 MHz, CDCl₃, 22° C.) δ 6.77-6.68 (m, 6H, —COC₂H₄CO—), 4.56-4.20 (m, 12H, —COOCH₂—), 4.13-4.05 (m, 6H, —COOCH₂CH₂—), 3.91-3.51 (m, 217H, —OCH₂CH₂— from 2.4 kDa MPEG), 3.49-3.42 (m, 6H, —CH₂CH₂NR₂), 2.01-1.86 (m, 6H, —OCH₂CH₂CH₂—), 1.47-0.90 (m, 9H, —CH₃).

### Example 9: General Procedure for Coating/Functionalization

2.4 k-V and 2.4 k-S

Clean samples of PDMS silicone rubber were exposed to ultraviolet/ozone (UVO) radiation for 1 hour, and then dried with nitrogen gas. 3-Mercaptopropyltrimethoxysilane was deposited onto the surface to provide thiol functional groups. These thiol-functionalized samples were immersed in polymer solution (2 mg dissolved in 1 mL of phosphate-buffered saline, pH 7.4), and left at room temperature for 1 day. Subsequently, the thiol functional groups on the PDMS surface reacted with the maleimide pendant groups on the polymer via Michael addition. The unreacted polymers were washed off the surface with isopropanol/water solution before use.

### Example 10: Contact Angles

2.4 k-V and 2.4 k-S

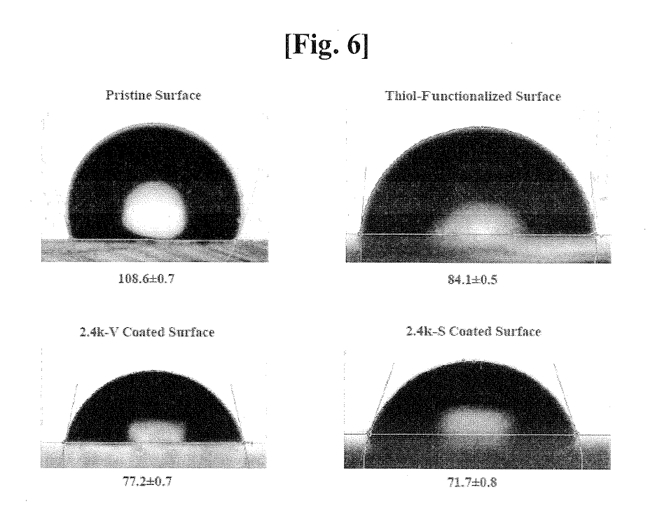

The static water contact angles of treated and untreated PDMS surfaces were measured to study wettability change after coating. As shown in FIG. 6, the contact angle of silicone rubber surface decreased drastically after UV/ozone passivation (108.6±0.7° vs. 22.3±1.00). After functionalizing with mercaptopropyltrimethoxysilane, the PDMS surface regained partial hydrophobicity (83.8±2.4°). Cationic polymer coating led to decreased wettability (2.4 k-S polymer-coated surface: 74.1±0.7°; 2.4 k-V polymer-coated surface: 75.1±0.4°). These findings demonstrate that the cationic polymer coatings increased the wettability of silicone rubber surface.

2.4 k-M, 2.4 k-MC, 10 k-M, and 10 k-MC

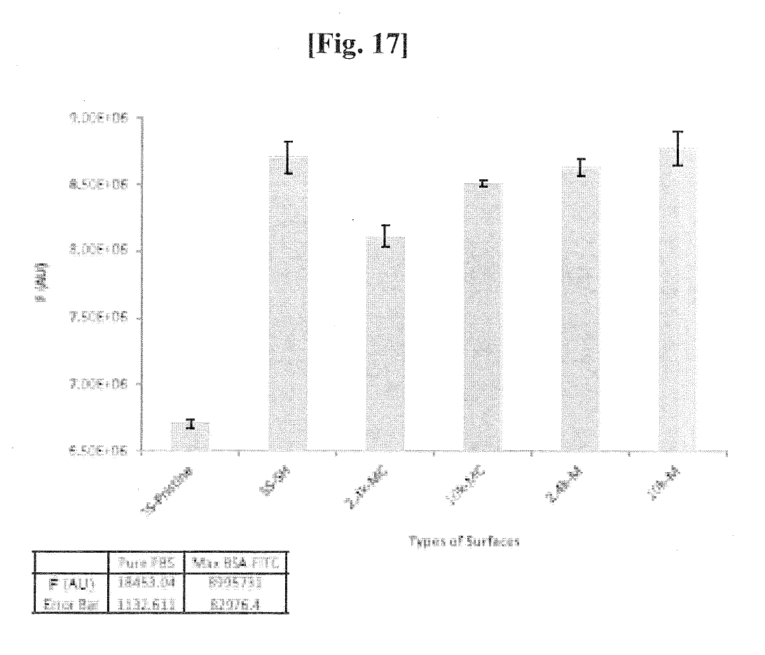

The static water contact angles of treated and untreated PDMS surfaces were measured to study wettability change. As shown in FIGS. 17a and 17b, the contact angle of silicone rubber surface decreased drastically after UV/ozone passivation (108.6±0.7° vs. 22.3±1.0°). After functionalizing with mercaptopropyltrimethoxysilane, the PDMS surface regained partial hydrophobicity (83.8±2.4°). All polymer coatings led to decreased wettability, with 10 k-MPEG incorporated polymer coatings (10 k-MC: 71.1±1.1°, 10 k-M: 70.5±0.9°) giving rise to slightly more hydrophilic surfaces as compared to shorter 2.4 k-MPEG incorporated polymer coated surfaces (2.4 k-MC: 74.7±0.6°, 2.4 k-M: 73.8±0.4°). The presence of cationic polycarbonates did not change the surface wettability significantly. These results indicate successful polymer coating and that polycarbonates confer hydrophobicity to the surface.

### Example 11: Grafting of Polymers 2.4 k-V and 2.4 k-S

2.4 k-V and 2.4 k-S

The XPS spectra of silicone rubber before and after polymer coatings were obtained and analyzed to affirm successful grafting of the polymers onto the thiol-functionalized PDMS surface. The atomic content of C1s, O1s, N1s and S2p peaks were analyzed and compared among the pristine, thiol-functionalized, 2.4 k-V and 2.4 k-S grafted surfaces. After successful vapour deposition of 3-mercaptopropyltrimethoxysilane onto the pristine surface, S2p peak appeared with an atomic content of 2.35%. Moreover, the surface grafted with 2.4 k-V and 2.4 k-S had comparable nitrogen atomic contents (i.e. 0.61% and 0.45 respectively). In the high resolution N1s spectrum of the coated surface, there are two distinct peaks. The first peak at 396.2 eV represents the amine from the maleimide pendant group (Scheme 3), and the second peak at 398.7 eV is from N,N-dimethylbutylammonium functional groups. These findings demonstrated successful grafting of the polymers onto the thiol-functionalized surface.

2.4 k-M, 2.4 k-MC, 10 k-M, and 10 k-MC

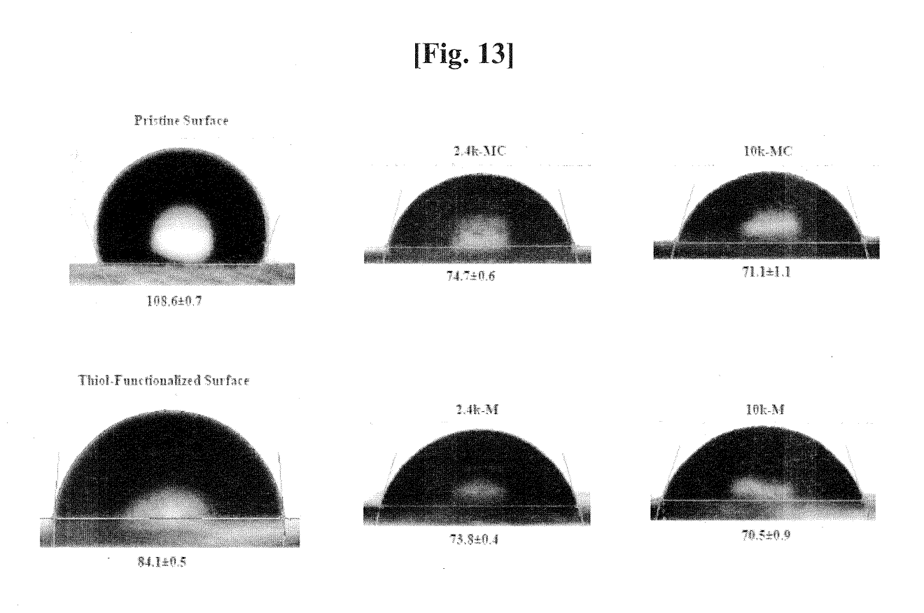

The XPS spectra of silicone rubber before and after polymer coating were obtained and analyzed to further affirm the successful grafting of the polymers onto the thiol-functionalized PDMS surface. The atomic content of C1s, O1s, N1s and S2p peaks were analyzed and compared among the pristine, thiol-functionalized, 2.4 k-M and 2.4 k-MC grafted surfaces. After successful vapour deposition of 3-mercaptopropyltrimethoxysilane onto the pristine surface, the thiol functionalized surface provided linker groups for Michael addition reaction with the pendantmaleimide moieties on the various polymers. The surface grafted with 2.4 k-M was observed with 1.85% nitrogen atomic content, while surface grafted with 2.4 k-MC recorded lower nitrogen content (0.26%) due to lower nitrogen content in CPC segment as compared to PMC segment and a higher content of CPC segment. In the high resolution N1s spectrum of the surface coated with 2.4 k-MC, there are two distinct peaks (FIG. 13). The first peak at 396.8 eV represents the amine from the maleimide pendant group (Scheme 4). The second peak at 399.2 eV correlated to the presence of N,N-dimethylbutylammonium functional groups. The surface coated with 2.4 k-M only displayed a single sharp peak at 396.9 eV, correlating to the presence of the amine from the maleimide moiety. These findings further confirm the successful coating of the polymers onto the thiol-functionalized surface.

### Example 12: Antibacterial Activity

2.4 k-V and 2.4 k-S

Pristine PDMS silicone and thiol-functionalized control surfaces, and surfaces coated with 2.4 k-V and 2.4 k-S, were tested against Gram-positive S. aureus and Gram-negative E. coli after incubation with the respective bacteria solution at 37° C. for 24 hours. With the pristine surface serving as the control, killing efficiency for the thiol-functionalized surface, as well as surfaces coated with the two copolymers was studied. The number of S. aureus in solution increased by 4.8 and 4.2 Log₁₀ after 24 hours of incubation for the pristine and thiol-functionalized PDMS surfaces, respectively (FIG. 7a). In contrast, the surfaces coated with cationic polymers showed a reduction in the number of bacteria in solution as compared to both the pristine and thiol-functionalized PDMS surfaces (8.0 Log₁₀ for 2.4 k-V and 8.9 Log₁₀ for 2.4 k-S), demonstrating 98.5% and 89.4% killing efficiencies, respectively, in the solution as compared to the pristine control. Moreover, there was significant reduction in viable colonies derived from E. coli solution (FIG. 7b) seeded on polymer-coated surfaces (7.4 Log₁₀ for 2.4 k-V and 8.0 Log₁₀ for 2.4 k-S) as compared to the pristine and thiol-functionalized surfaces (˜8.7 Log₁₀). The results translated to killing efficiencies of 93.9% and 82.5% for surfaces coated with 2.4 k-V and 2.4 k-S, respectively. The 2.4 k-V polymer coating had a greater killing effect against both S. aureus and E. coli than the 2.4 k-S polymer coating, possibly due to a greater contact of the cationic moieties with the bacteria (FIG. 1).

2.4 k-M, 2.4 k-MC, 10 k-M, and 10 k-MC

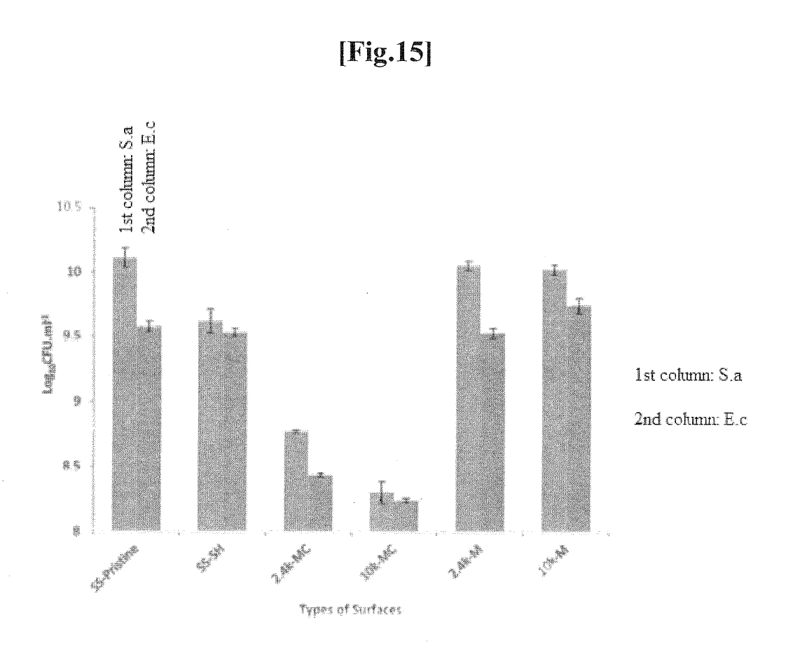

Pristine PDMS silicone surface and surfaces coated with the 4 polymers respectively were tested against both Gram-positive bacteria S. aureus and Gram-negative bacteria E. coli. All samples were incubated with the respective bacteria solution at 37° C. for 24 hours, after which the solution was diluted to respective concentrations for colony counting. Bacterial solution seeded on pristine (10.1 Log CFU·ml⁻¹), thiol functionalized (9.6 Log CFU·ml⁻¹) and non-cationic polymer surfaces 2.4 k-M (10.0 Log CFU·ml⁻¹) and 10 k-M (10.0 Log CFU·ml⁻¹) had a large amount of live S. aureus cells as seen in FIG. 15. In contrast, the solution on the surfaces coated with the cationic polymers 2.4 k-MC (8.8 Log CFU·ml⁻¹) and 10 k-MC (8.3 Log CFU·ml⁻¹) had an approximated 2 logarithmic reduction in bacteria colonies as compared to the pristine surface, demonstrating that 95.5% and 98.4% of killing efficiencies respectively. This trend was held constant when the surfaces were tested against E. coli. Significant reduction of viable colonies derived from E. coli solution was observed for the surfaces coated with 2.4 k-MC (8.4 Log CFU·ml⁻¹) and 10 k-MC (8.2 Log CFU·ml⁻¹), recording killing efficiencies of 92.7% and 95.5% respectively. These results demonstrated that 2.4 k-M and 10 k-M without cationic polycarbonate were unable to eradicate bacteria in solution, while 2.4 k-MC and 10 k-MC with cationic polycarbonate killed bacteria in solution that was in contact with the coated surfaces.

### Example 13: Antifouling Activity

2.4 k-V and 2.4 k-S

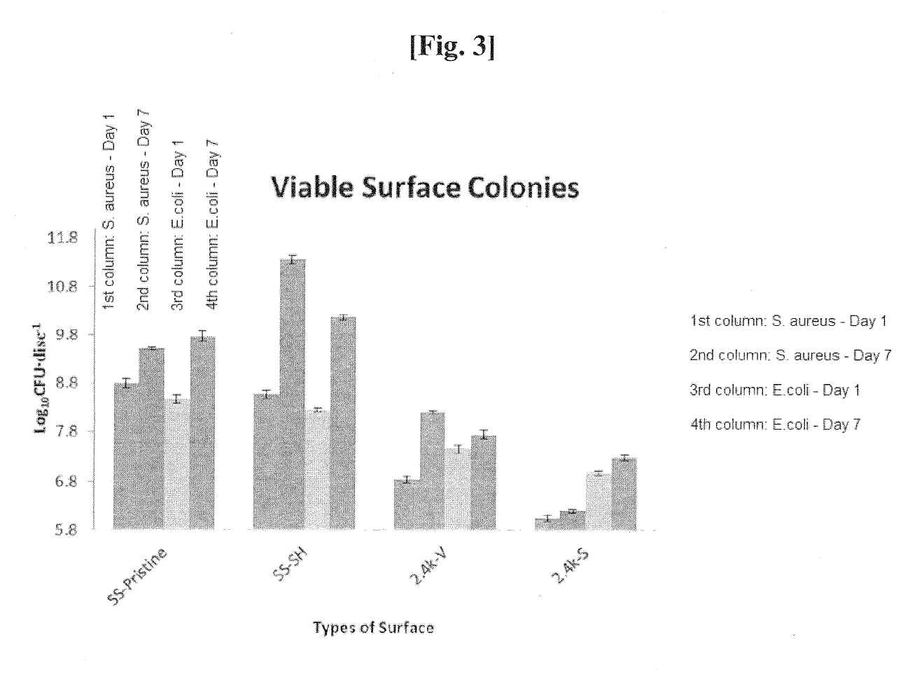

Antifouling activity is the most important property that ideal catheters should possess to prevent catheters-associated infections. To quantitatively investigate bacteria fouling on the uncoated thiol- and polymer-coated silicone rubber surfaces, the number of viable bacterial cells fouled on the surfaces was measure (FIG. 3). A high number of S. aureus and E. coli cells were fouled onto both pristine and thiol-functionalized surfaces after 7 days of incubation (S. aureus: 8.8 Log₁₀ and 8.6 Log₁₀, respectively. E. coli: 8.5 Log₁₀ and 8.2 Log₁₀, respectively). There was no significant difference in the number of viable cells observed on the pristine and thiol-functionalized surfaces. In contrast, the polymer-coated surfaces showed significant antifouling activity with 2.4 k-S being more effective. For example, the number of S. aureus and E. coli was lower by ˜3 Log₁₀ on the 2.4 k-S coated surface at 7 days as compared to that on the pristine surface.

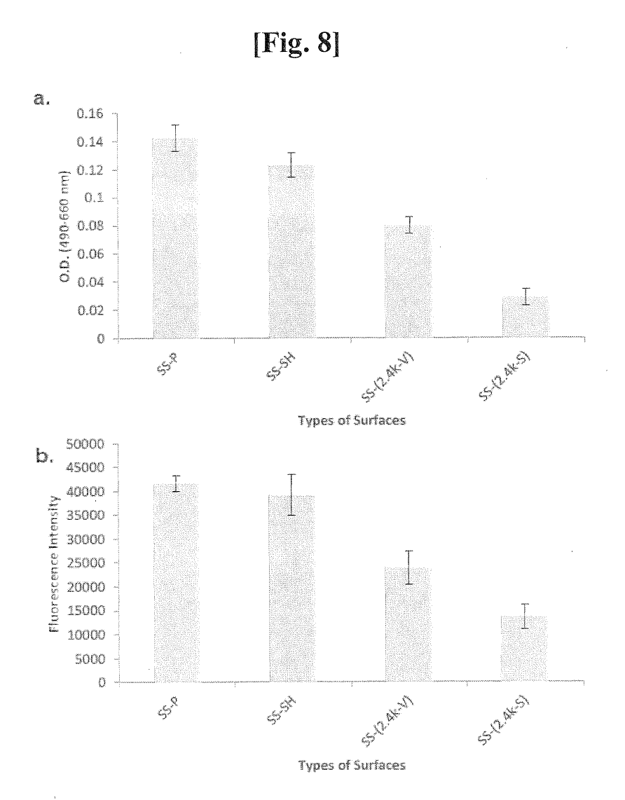

A complementary XTT assay, which measures bacterial cell viability, was performed to further evaluate antifouling activity of the coated and uncoated surfaces, and the results are well correlated to the viable surface colonies determined by agar plating (FIG. 8a). Cell Titer-Blue@ cell viability assay was employed to quantify fouling of E. coli as XTT assay was unable to detect E. coli. Similar to S. aureus, the pristine and thiol-functionalized surfaces showed extensive E. coli fouling, while polymer coatings inhibited E. coli fouling with 2.4 k-S coating being more promising (FIG. 8b). LIVE/DEAD bacterial cell staining was performed to further confirm the antifouling property of polymer coatings against both S. aureus and E. coli. Live and dead (a) S. aureus; and (b) E. coli cell staining on uncoated silicone PDMS surface and surfaces coated with thiol, 2.4 k-V and 2.4 k-S was performed. The surfaces were imaged under confocal laser scanning microscopy after 1 and 7 days of incubation. It was found that the pristine and thiol-functionalized surfaces showed significant fouling of bacteria, and a large number of live cells were seen after 1 day and 7 days of incubation. The surface coated with the polymer 2.4 k-S had significantly less fouling, as compared to surface coated with polymer 2.4 k-V, which is in agreement with both viable surface colonies (FIG. 3) and XTT assay results (FIG. 8).

Biofilm on surfaces consists of bacteria, their secretions and organic debris, and is extremely difficult to remove. From SEM analysis, the control surfaces without polymer coating developed biofilm especially at 7 days. In sharp contrast, no biofilm was formed on the polymer 2.4 k-S coating. Taken together, this data suggests that the polymer 2.4 k-S with the optimal composition inhibited bacteria fouling, effectively preventing biofilm formation.

2.4 k-M, 2.4 k-MC, 10 k-M, and 10 k-MC

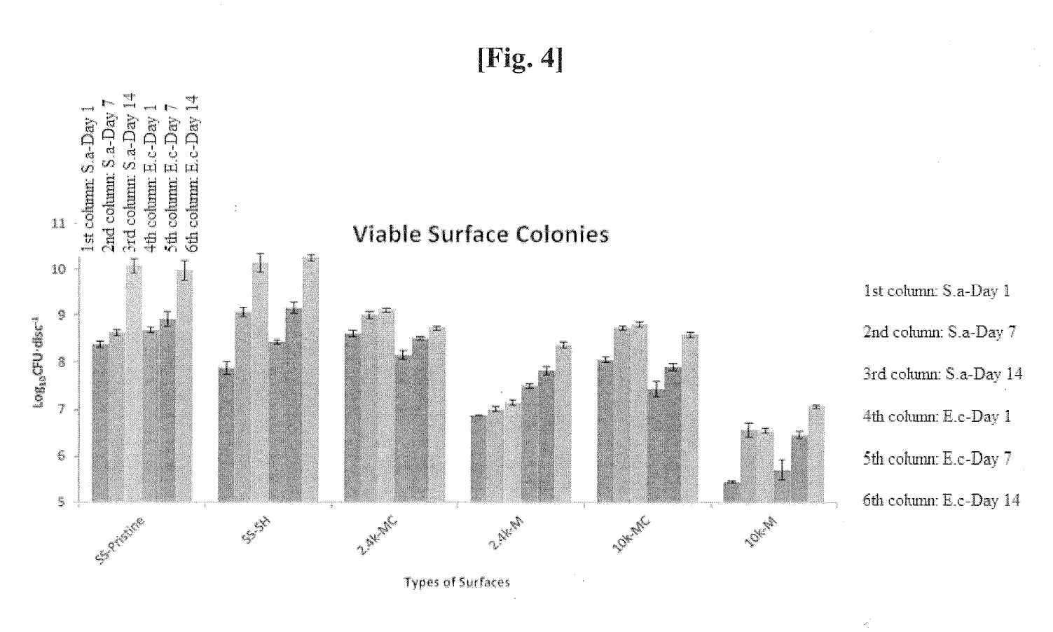

To quantitatively investigate bacteria fouling on uncoated and polymer-coated silicone rubber surfaces, surviving S. aureus and E. coli cells left on the surfaces after washing were counted (FIG. 4). The pristine surface, thiol-functionalized surface, and the surfaces coated with cationic polymers had a higher amount of S. aureus and E. coli cells. Live and dead (a) S. aureus; and (b) E. coli cell staining on uncoated silicone PDMS surface and surfaces coated with thiol, 2.4 k-MC, 2.4 k-M, 10 k-MC and 10 k-M was performed. The surfaces were imaged under confocal laser scanning microscopy after 1, 7 and 14 days of incubation. From the presence of dead cells as shown by LIVE/DEAD bacterial viability staining (FIG. 4), the thiol functional groups killed the bacteria on the surface, and live cells were also attached to the surface by anchoring onto the underlying dead cells. The coatings of the cationic polymers 1.4 k-MC and 10 k-MC were unable to prevent bacteria fouling. In contrast, 1.4 k-M and 10 k-M inhibited bacteria fouling with 10 k-M being more effective against both S. aureus and E. coli over 14 days. For example, 20 k-M coating led to more than 4 Log₁₀ reduction for live S. aureus fouling and -3 Log₁₀ reduction for E. coli as compared to the pristine surface (FIG. 4). Complementary XTT (and cell titer blue assays which measure viability of S. aureus and E. coli respectively, were performed and the results are well correlated to FIG. 4 and FIG. 15, with surfaces coated with solely PEG components recorded the strongest antifouling activity.

Prevention and removal of biofilm is notoriously difficult. Pristine and thiol-functionalized surfaces developed biofilm after 7 and 14 days of incubation, confirmed by SEM (FIG. 17) and viable surface colony (FIG. 4) analyses. Moreover, after 7 days of incubation with S. aureus bacteria, surfaces coated with 2.4 k-MC and 10 k-MC started to foul, with the former surface fouling most extensively. S. aureus biofilm was observed on 2.4 k-MC coated surface after 14 days of incubation. Compared to S. aureus, E. coli started to foul earlier and biofilm was seen on both 2.4 k-MC and 10 k-MC coated surfaces after 14 days of incubation. For 2.4 k-M coated surface without cationic polycarbonate, significant S. aureus and E. coli fouling was observed after 7 and 14 days of incubation, respectively. However, 10 k-M coating effectively prevented S. aureus and E. coli biofilm formation over 14 days. These results further demonstrated that 10 k-M coating effectively prevented fouling of both Gram-positive and Gram-negative bacteria, inhibiting biofilm formation.

### Example 14: Protein Adsorption, Platelet Adhesion and Hemolysis

2.4 k-V and 2.4 k-S

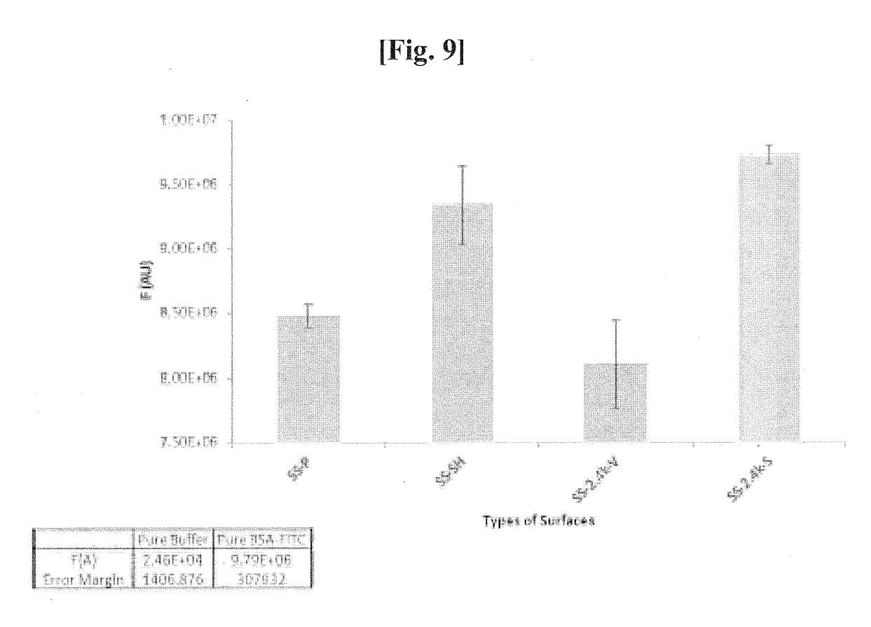

The uncoated and coated surfaces were examined for their protein adsorption, platelet adhesion and hemolysis to study blood compatibility. Proteins are present in blood and adsorption of the proteins may mask the antifouling function of the polymer coatings. FITC-labeled BSA was used as a model protein. BSA-FITC solution was incubated with the coated and uncoated pristine PDMS rubber surfaces for one day at 37° C. From the fluorescence microscopic images of the surfaces the pristine surface showed the greatest degree of protein adsorption. Protein adsorption was greatly decreased on the surface coated with the polymer 2.4 k-S as shown by fluorescence spectroscopy studies (FIG. 9), which may be attributed to the structure of the polymer.

The PEG block was positioned at the top most position within the covalently tethered tri-block copolymer 2.4 k-S (FIG. 1), preventing proteins from fouling onto the surface. Meanwhile, the surface coated with the 2.4 k-V copolymer demonstrated a higher amount of bacteria and protein fouling, which was most likely due to insufficient coverage of the surface by PEG since the PEG block was positioned at the periphery of the tethered tri-block polymer. The large disparity in molecular size between the cationic block in relation to the PEG block may also shield the smaller PEG block on the surface coated with 2.4 k-V polymer, compressing the antifouling PEG component closer to the PDMS surface as compared to the PEG block on the surface coated with 2.4 k-S polymer.

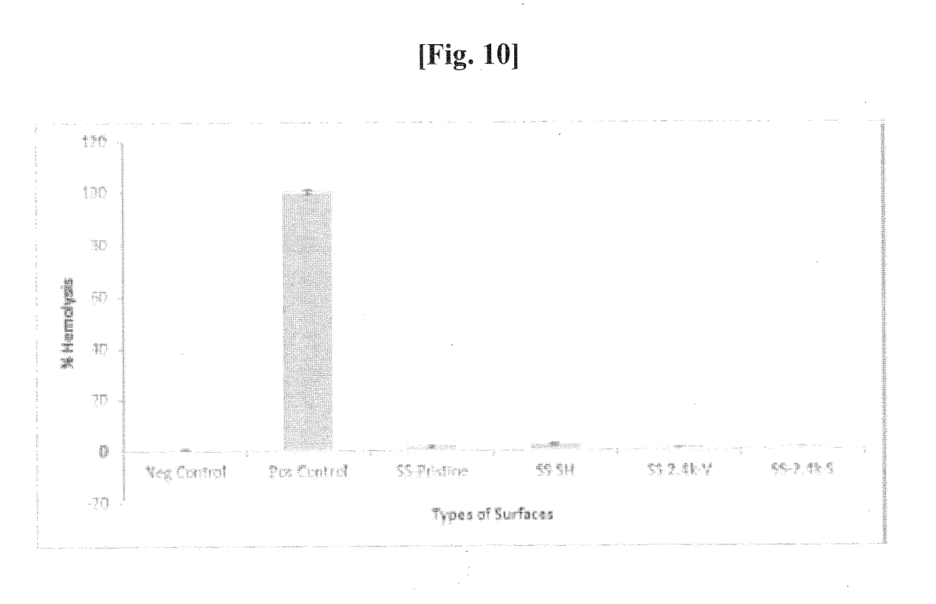

Platelet adhesion may cause thrombus formation. Platelet adhesion on the pristine and copolymer-coated surfaces was examined by SEM analysis. Platelet fouling was seen on the entire pristine surface. Moreover, the surface coated with 2.4 k-V was shown to attract a number of platelets. However, very few platelets were observed on the surfaces coated with the polymer 2.4 k-S coated surface, implying that 2.4 k-S coating successfully prevented platelet fouling. Hemolytic activity of the untreated and polymer-coated surfaces was evaluated using rat red blood cells. All surfaces, coated or uncoated, exhibited almost no or minimal hemolysis after incubation with red blood cells (FIG. 10), which is ideal for use as antibacterial and antifouling coatings especially for intravenous catheters.

2.4 k-M, 2.4 k-MC, 10 k-M, and 10 k-MC

Proteins present in blood and subsequent adsorption of these blood proteins may act as an underlying anchoring layer for adhesion of surrounding bacteria, hence masking the antifouling/antimicrobial functions of the polymer coatings. Therefore, FITC-labeled BSA was used as a standard protein to study protein adsorption on the polymer-coated silicone rubber surfaces. BSA-FITC solution was incubated with the treated and pristine PDMS rubber surfaces for one day at 37° C. Consequently, the pristine surface showed the greatest protein adsorption, analyzed by both florescence microscopy and spectroscopy. Protein adsorption was greatly reduced on all other coated surfaces.

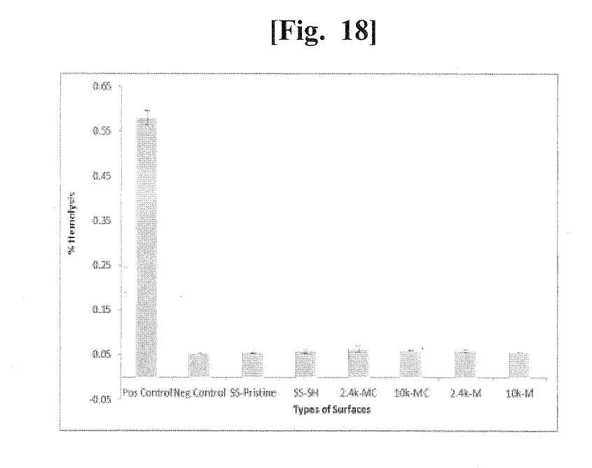

Blood platelet adhesion may also compromise the antibacterial and antifouling functions of the polymer coatings via clotting. It is evident from FE-SEM analysis that the pristine surface had significant blood platelet fouling. The 10 k-M coating with the optimal composition showed almost no presence of blood platelets, indicating that the polymer coating may reduce occurrence of thrombosis. Moreover, all surfaces, coated or uncoated, had almost no or minimal hemolysis after treatment with red blood cells from rats (FIG. 18).

### INDUSTRIAL APPLICABILITY

In conclusion, triblock copolymers of antifouling PEG, antibacterial cationic polycarbonate and maleimide-functionalized polycarbonate (for anchoring onto silicone rubber surface) may be successfully synthesized with different molecular structure but similar molecular length for each block via metal-free organocatalytic ring-opening polymerization for surface coating. The polymers may be grafted onto thiol-functionalized PDMS silicone rubber surfaces through Michael addition reaction. The surface coated with 2.4 k-S was the most effective against S. aureus and E. coli fouling over one week, preventing biofilm formation. This polymer coating was also able to resist protein fouling and platelet adhesion, and did not cause significant hemolysis. This polymer coating holds great potential for prevention of bacterial fouling and catheter-associated bloodstream infections.

Additionally, diblock copolymers of PEG with different chain length and maleimide-functionalized polycarbonate, and diblock copolymers of PEG with different chain length and cationic polycarbonate having maleimide groups randomly distributed were successfully synthesized. The polymer having PEG of Mn 10 kDa without cationic polycarbonate effectively inhibited fouling of both Gram-positive and Gram-negative bacteria, preventing biofilm formation without inducing protein adsorption, platelet adhesion or hemolysis. The polymer coating further has great potential for use as catheter coating to prevent various infections.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A copolymer comprising monomer units represented by formulas (I) and (II): 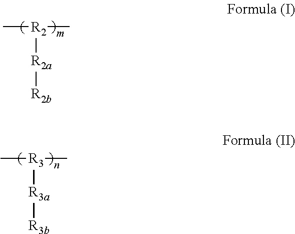
wherein the copolymer is terminated on one end by R₁ and on the other end by R₄;
R₁ comprises an antifouling moiety;
R₄ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
R₂ and R₃ are independently optionally substituted hetero-C₁₋₁₀-alkyl, wherein one or more chain carbon atoms is optionally replaced by a heteroatom;
R₂ₐ and R₃ₐ are independently optionally substituted hetero-C₁₋₁₀-alkyl, wherein one or more chain carbon atoms is optionally replaced by a heteroatom;
R_{2b} comprises an anchoring moiety;
R_{3b} comprises an antibacterial moiety;
m is an integer in the range of 2 to 20; and
n is an integer in the range of 0 to 100.

2. The copolymer according to claim 1, wherein R₁ is a polymer residue comprising an antifouling moiety, optionally the antifouling moiety comprises an alkoxyalkylene.

3.-39. (canceled)

40. The copolymer according to claim 2, wherein said copolymer is a diblock copolymer, wherein one block consists of R₁, and the other block consists of repeating units of Formula (I); optionally
wherein said copolymer is a diblock copolymer, wherein one block consists of R₁, and the other block consists of randomly arranged monomer units of Formulas (I) and (II); more optionally
wherein said copolymer is a triblock copolymer, wherein one block consists of R₁, the second block consists of Formula (I), and the third block consists of Formula (II); and further optionally
wherein said copolymer is a triblock copolymer, wherein one block consists of R₁, the second block consists of Formula (II), and the third block consists of Formula (I).

41. The copolymer according to claim 1, wherein R₁ is a polymer residue selected from the group consisting of poly(oxyalkylene), methoxypoly(oxyalkylene), and poly(alkoxy acrylate); and optionally
R₁ is a polymer residue selected from the group consisting of poly(ethylene glycol) (PEG), methoxypoly(ethylene glycol) (mPEG), poly(methoxyethyl methacrylate) and poly(ethoxyethyl methacrylate).

42. The copolymer according to claim 1, wherein R₁ is a polymer residue with a molecular weight in the range of 2,000 to 20,000,
of about 2,400, about 10,000.

43. The copolymer according to claim 1, wherein the anchoring moiety comprises an α-β-unsaturated carbonyl group; optionally
the anchoring moiety is selected from the group consisting of maleic acid, maleamic acid and maleimide groups.

44. The copolymer according to claim 1, wherein the antibacterial moiety comprises a cation; and optionally
the antibacterial moiety comprises a quaternary ammonium.

45. The copolymer according to claim 1, wherein Formula (I) is of Formula (IA) and Formula (II) is of Formula (IIA): 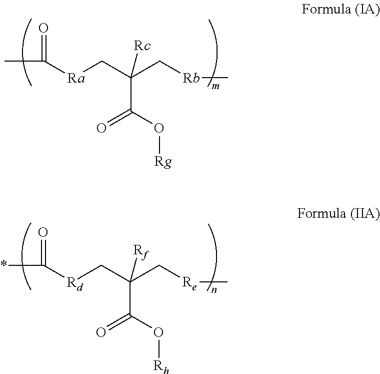
wherein m and n are as defined in claim 1;
Rₐ, R_{b}, R_{c}, R_{d}, Rₑ and R_{f} are independently C(R₅)₂, O or N(R₅);
R₅ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
R_{g} comprises an anchoring moiety; and
Rₕ comprises an antibacterial moiety.

46. The copolymer of claim 45, wherein R_{g} is of formula (i): 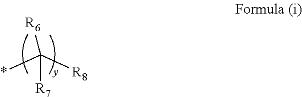
wherein * is the point of attachment;
R₆ and R₇ are independently H, optionally substituted alkyl, optionally substituted alkenyl, optionally substituted alkynyl, optionally substituted aryl, optionally substituted heteroaryl, optionally substituted carbocycle, or optionally substituted heterocarbocycle;
R₈ is an anchoring moiety comprising a α-β-unsaturated carbonyl group; and
y is an integer in the range of 1 to 5.

47. The copolymer of claim 46, wherein R₈ is selected from the group consisting of maleic acid, maleamic acid and maleimide.

48. The copolymer of claim 45, wherein Rₕ is of formula (ii): 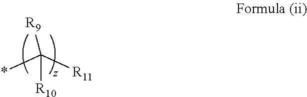
wherein R₉ and R₁₀ are independently H, optionally substituted alkyl, optionally substituted alkenyl, optionally substituted alkynyl, optionally substituted aryl, optionally substituted heteroaryl, optionally substituted carbocycle, or optionally substituted heterocarbocycle;
R₁₁ is an aryl or heteroaryl substituted with at least one cation; and
Z is an integer in the range of 1 to 5; and optionally
R₁₁ is selected from the group consisting of aryl or heteroaryl substituted with at least one quaternary ammonium cation.

49. The copolymer of claim 1, wherein Formula (I) is of Formula (IB): 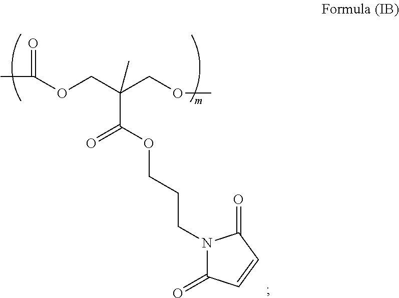
wherein m is as defined in claim 1; and optionally
wherein Formula (II) is selected from the group consisting of: 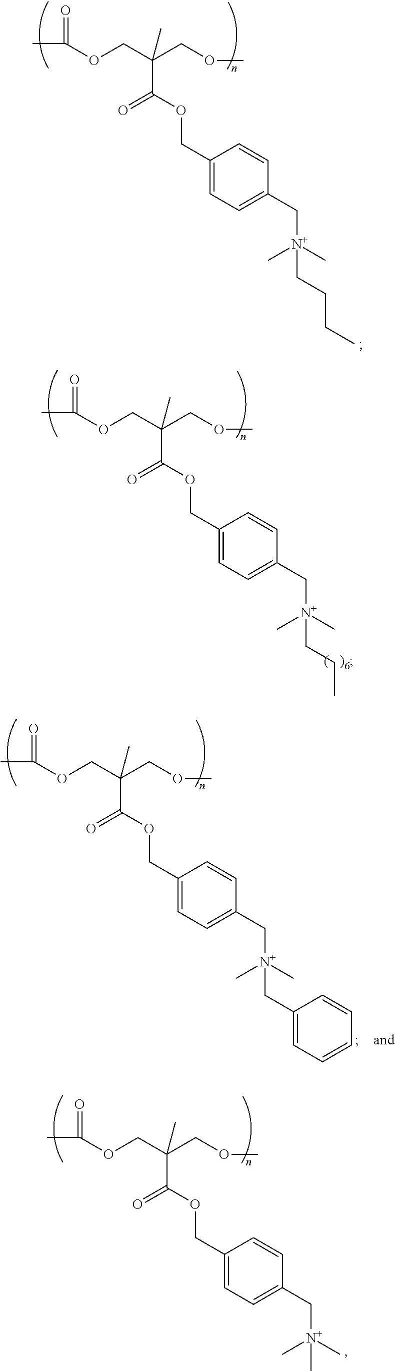
wherein n is as defined in claim 1.

50. The copolymer according to claim 1, selected from the group consisting of: 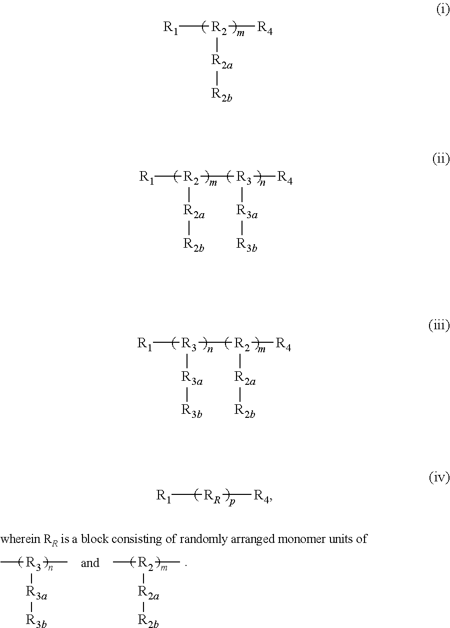
wherein R₁, R₂, R₃, R₄, R₂ₐ, R_{2b}, R₃ₐ, R_{3b}, m and n are as defined in any one of claims 1 to 12; and
p is an integer in the range of 1 to 50.

51. The copolymer of claim 1, wherein m is in the range of 2 to 7; and optionally wherein n is in the range of 70 to 95.

52. A method of synthesizing a copolymer comprising monomer units represented by formulas (IIIA) and (IIIB): 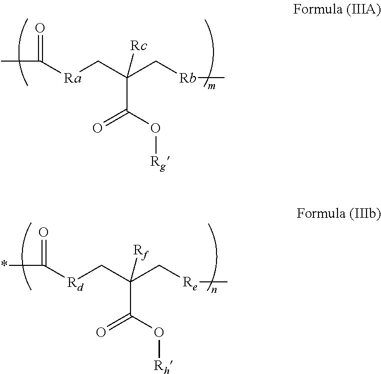
wherein the copolymer is terminated on one end by R₁ and on the other end by R₄;
R₁ is a polymer residue comprising an antifouling moiety;
R₄ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
Rₐ, R_{b}, R_{c}, R_{d}, Rₑ and R_{f} are independently C(R₅)₂, O or N(R₅);
R₅ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
R_{g}′ represents protected R_{g}, and Rₕ′ represents aryl or heteroaryl substituted with at least one substituent capable of being quaternized,
wherein R_{g} comprises an anchoring moiety; in the range of 2 to 20; and
n is an integer in
m is an integer
the range of 0 to 100,
the method comprising the operation of:
(i) performing a ring-opening polymerization reaction in a reaction mixture comprising compounds of Formula (IC), H—R₁, and compounds of Formula (IIC): 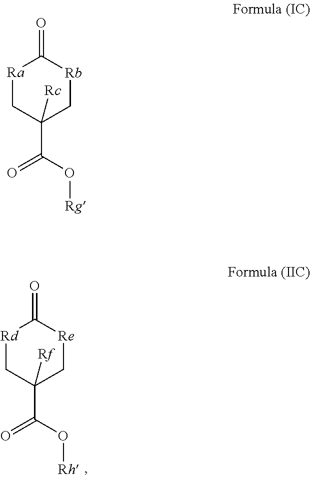
with the proviso that compounds of Formula (IIC) are present only when n≠0,
thereby forming a copolymer comprising monomer units of Formula (IIIA) and/or (IIIB); optionally
the copolymer is selected from the group consisting of: 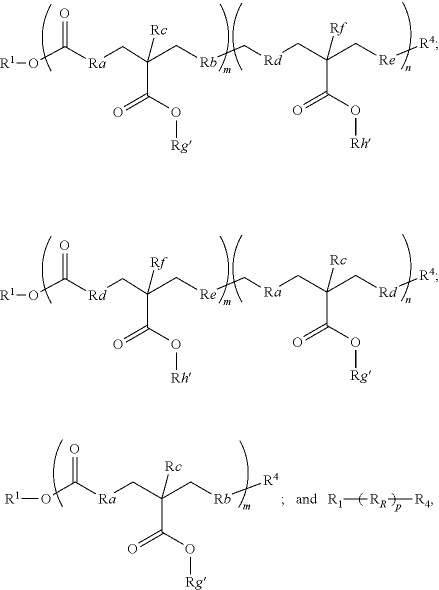
wherein Ra, Rb, Rc, Rd, Re, Rf, Rg′, Rh′, R₁, R₄, m and n are as defined herein;
R_{R} is a block consisting of randomly arranged monomer units of 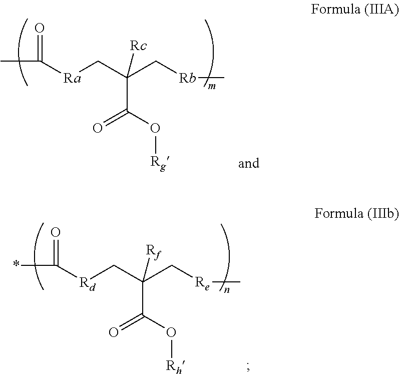
and p is an integer in the range of 1 to 50; more optionally
further comprising
(ii) performing a deprotection reaction on the copolymer formed herein, thereby exposing the R_{g} anchoring moiety(s); and
(iii) when n≠0, performing a quaternization reaction,
thereby forming a copolymer comprising monomer units represented by formulas (IA) and/or (IIA): 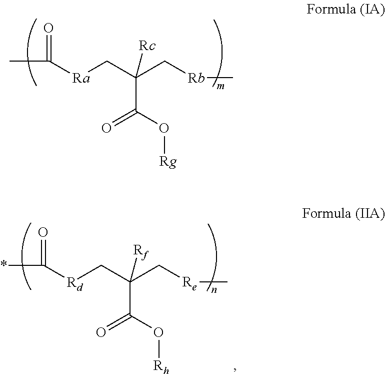
wherein the copolymer is terminated on one end by R₁ and on the other end by R₄;
R₁, R₂, Ra, Rb, Rc, Rd, Re, Rf, Rg, m and n are as defined herein; and
Rₕ comprises a cation.

53. The method according to claim 52 wherein operation (i) further comprises a ring opening polymerization catalyst; and optionally
the ring-opening polymerization catalyst is selected from the group consisting of 1,8-diazabicyclo[5.4.0]undec-7-ene (DBU), tin(II) 2-ethylhexanoate (Sn(Oct)₂) and tin(II) trifluoromethanesulfonate (Sn(OTf)₂).

54. The method according to claim 52, wherein H—R₁ is selected from the group consisting of poly(ethylene glycol) (PEG), methoxypoly(ethylene glycol) (mPEG), poly(methoxyethyl methacrylate) and poly(ethoxyethyl methacrylate).

55. The method according to claim 52, wherein the deprotection is carried out by dissolving the copolymer formed in operation (i) in toluene; and optionally
the quaternization reagent is selected from the group consisting of amine, dimethylbutylamine, dimethyloctylamine, dimethylbenzylamine, and trimethylamine.

56. A method of attaching a copolymer to a substrate, comprising attaching the anchoring moiety of said copolymer to an anchoring segment on said substrate;
wherein the copolymer comprises monomer units represented by formulas (I) and (II): 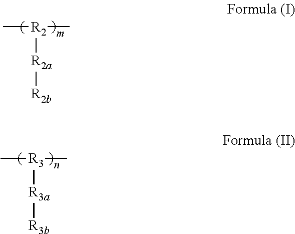
wherein the copolymer is terminated on one end by R₁ and on the other end by R₄;
R₁ comprises an antifouling moiety;
R₄ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
R₂ and R₃ are independently optionally substituted hetero-C₁₋₁₀-alkyl, wherein one or more chain carbon atoms is optionally replaced by a heteroatom;
R₂ₐ and R₃ₐ are independently optionally substituted hetero-C₁₋₁₀-alkyl, wherein one or more chain carbon atoms is optionally replaced by a heteroatom;
R_{2b} comprises an anchoring moiety;
R_{3b} comprises an antibacterial moiety;
m is an integer in the range of 2 to 20; and
n is an integer in the range of 0 to 100; optionally
wherein the anchoring segment comprises one or more thiol groups; more optionally
wherein the copolymer is attached to the substrate via a Michael addition.

57. An article comprising a substrate and a coating comprising a copolymer comprising monomer units represented by formulas (I) and (II): 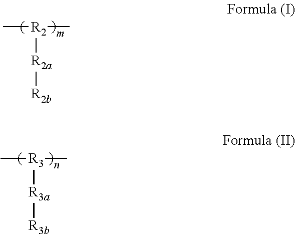
wherein the copolymer is terminated on one end by R₁ and on the other end by R₄;
R₁ comprises an antifouling moiety;
R₄ is H, optionally substituted alkyl, optionally substituted alkenyl, optionally substituted alkynyl, optionally substituted aryl, optionally substituted heteroaryl, optionally substituted carbocycle, or optionally substituted heterocarbocycle;
R₂ and R₃ are independently optionally substituted hetero-C₁₋₁₀-alkyl, wherein one or more chain carbon atoms is optionally replaced by a heteroatom;
R₂ₐ and R₃ₐ are independently optionally substituted hetero-C₁₋₁₀-alkyl, wherein one or more chain carbon atoms is optionally replaced by a heteroatom;
R_{2b} comprises an anchoring moiety;
R_{3b} comprises an antibacterial moiety;
m is an integer in the range of 2 to 20; and
n is an integer in the range of 0 to 100.
